(19) United States
(12) Patent Application Publication
(10) Pub. No.: US 2021/0354566 A1
(43) Pub. Date: Nov. 18, 2021

(54) Scalable Tractive-Power System For Electric Railway-Vehicles Integrated into All-Wheel Electric Steering and Electric Braking Systems, Deriving 90% To 99% Traction and Dynamic Efficiency

(71) Applicant: JACOB BEN-ARI, BAT YAM (IL)

(72) Inventor: JACOB BEN-ARI, BAT YAM (IL)

(21) Appl. No.: 17/352,411

(22) Filed: Jun. 21, 2021

(51) Int. Cl. B60L 7/22; B61C 3/00; B61H 5/00

(52) U.S. Cl. CPC B60L 7/22; B60L 2200/26; B61H 5/00; B61C 3/00

(57) ABSTRACT

A railway-vehicles scalable tractive power system, integrated into all-wheel steering and braking systems to leverage synergies between plurality of differently designed electric traction-motors, electric steering motors and electric brake calipers; configured with plurality of sensors to eliminate wheel-dragging at virtually 100% dynamic efficiency. A fully automated electronic clutch-system attached to selected electric traction motors configured to perform above 90% traction efficiency by coupling to wheels selected electric traction-motors in their high efficiency range of operation, or de-coupling and replacing electric traction-motors with another electric traction-motors while the vehicle is changing speed or when it requires higher or lower tractive-power, from forward-motion start to top-rated speed. A holistic controller is configured with multi-objective optimization design (MOOD) procedures; measures complex variable parameters and values, finds the required trade-off among design objectives, and improves pertinence of solutions. Plurality of electronic-couplers is monitoring changing distance between wagons, whereas the controller is maintaining optimal ‘free-slack’ between wagons to prevent ‘run-in’ and ‘run-out’ scenarios with precise maneuverability between electric traction-motors actuation and electric brake-calipers actuation.

### CROSS-REFFERENCE TO RELATED APPLICATION

This application is a modification of application Ser. No. 16/399,194—filed Apr. 30, 2019, by the above-named inventor, published Nov. 21, 2019 (2019/0351895 A1)—to fit railway-vehicles. This application is further a direct improvement of application Ser. No. 17/073,899, filed Oct. 19, 2020. All applications are founded on the same scientific-philosophy, which deals-with variety of electric vehicles; it is radically modifying traditional railway-locomotives and articulated wagons engineering to combat the day-after-day increasing catastrophic global environment and more.

### TECHNICAL FIELD AND THE PHILOSOPHY FUNDAMENT OF THE DISCLOSURE

This disclosure is configured with a holistic controller at the center stage of overall management since the holistic controller is accomplishing every logic associated with excellent and safe handling; electing the most efficient alternatives for traction, steering, and braking, by utilizing plurality of Multi-Objective Optimization Design (MOOD) procedures simultaneously and employing Evolutionary Multi-objective Optimization (EMO). The main purpose to elect a holistic processes was to take all the steps in the MOOD procedure into a centralize account:
the multi-objective problem (MOP) statement.
the Evolutionary Multi-objective Optimization (EMO) process; and
the Multi-Criteria Decision Making (MCDM) step.

Above all, with a holistic controller management of plurality of electric traction-motors, electric steering-motors and electric brake-calipers along the railway-vehicle, the overall efficiency will raise above 90% which eventually solves all major challenges before railway industry, such as:
meet all government pollution requirements.
(ii) reduce excessive fuel & electricity spending.
(iii) establish alternate energy solutions; and
(iv) reduce the massive wheels and rail repair expenditures.

In any form of traditional railway-vehicles, mechanical configuration means that essential functions of traction, steering, braking, and running stability is considered separately (FIG. 2), and the components are manufactured by various sub-contractors. To satisfy the paramount concerns before all railway companies, this application discloses an insight of systems that leverage synergies between an assortment of differently designed electric traction-motors integrated into ail-wheel electric steering motors and electric brake calipers, along the railway-vehicle (FIG. 3) to generate virtually 100% dynamic efficiency while moving on rail.

The primary factors separating this disclosure from traditional mechanical engineering is the fact that this disclosure follows the selective evolution of nature because, of all our scientific developments and the technological benefits we have produced over our ‘very short’ documented history of 6,000 years, nothing defeats the efficiency of integrated motoric, and the precision, as introduced in nature, especially in humans throughout the 2.5 to 3 billion years of ‘animal species technology development,’ where only the best emerged ‘technology’ survived.

At emergence of the transportation industry, three paramount engineering oversights of nature efficient motoric experience, directed the transportation industry into strict profit considerations, and with total ignorance to wide-spread pollution consequences that contributed to destruction of the global environment. Yet, it also counteracted against development of the “correct” engineering that is emerging in the last two decades, almost a century after the industry abandoned electric vehicles technology in the 1930s for cheap oil.

The first ‘off target’ engineering mistake in the transportation sector was overlooking nature's efficient energy production and exploitation as presented in animals, with which super-efficient mobility is the rule of thumb. In nature, virtually the entire energy production resembles energy production in Internal Combustion Engines (ICE) by oxidizing (burning) carbon containing resources. The authentic difference is the way this energy is applied to the target, be it wheels or muscles. Whereas ICE deliver the combustion energy through multiple, wasteful mechanical components to wheels, realizing just about 24-28% efficiency; in humans however, energy produced by oxidation [burning food] is first transformed into high energy molecular compound, ATP (Adenosine Triphosphate)—that may correspond to any form of energy storage (battery-packs, ultra-capacitors)—then, on demand, the stored energy in the ATP molecules is converted into electrical energy that runs through neurons [electrical wiring], to the selected muscle-fibers, to excite and accomplish a distinct motion under loop with our holistic brain. Yet the efficiency of this procedure is above 90%, which is remarkably similar to efficient energy transfer from battery-packs/ultra-capacitors/flywheels to electric traction-motors.

The second ‘off target’ engineering misstep, overlooked nature's practice in distribution of power among plurality of ‘motoric’ muscles. It is obvious that one ICE's crankshaft cannot move dozens of consumers [ICE contains about 2,000 parts with all attachments] and remain efficient when it reaches the wheels. Yet, it is beyond logical perception that with today's technology, when digital controls afford easy distribution of power among plurality of e-motors for better handling, superb efficiency and cleaner environment, manufacturers continue to design EVs with a single, big electric motor that runs inefficient most of the times; or locomotives and semi-trailers with solid-axles and a huge electric traction-motors between the wheels that runs inefficient most of the times.

The third paramount ‘off target’ engineering misstep overlooked nature's evolution of motoric control. Humans have the most sophisticated brain, which consist of three main parts: cerebrum, cerebellum, and brainstem. The attention must go to cerebellum that controls the coordination of voluntary movements; it receives sensory information from the brain and spinal cord and fine-tunes the precision and accuracy of the motoric activity. During 2.5 billion yeas of evolution, which is about 400,000 times our 6,000 written history, giant animals populated the planet. They all disappeared because their tiny brain could not support their physiological needs. A simple deduction is that motoric strength begins in brain “management” and not in the size of the muscles [electric-motors].

The transportation industry was sustained for about a century on genuine mechanical gears without Electronic Control Units (ECUs); while in the railway industry it was much longer than a century. In the 1970s, when pollution regulation came in effect, automobiles were equipped with a tiny ECUs to precisely regulate the 14.7 air/fuel ratio with a loop between a O2 sensor and the fuel supply to get more efficient fuel combustion. Later, plurality of separate ECUs was manufactured for electronic ignition, fuel injection control, airflow-meters, air-conditioning, heater control and many more. Holistic controller was never on the agenda because different subcontractors manufactured different ECUs for their specific product.

The inevitable confirmation that the above-named inventor's philosophy is on the money came about with the VW-Audi diesel scandal. The manufacturer's engineering team directed its first attention exclusively to the diesel engines to produce the most power to reach the wheels before an ECU was designed to manage the pollution-output while maintaining dissent power to the wheels. After numerous attempts and about billions of Euros, engineers gave-up because the pollution standards were met only with massive catalytic converters that blocked most of the diesel engine power. We all know what was the “solution.” The same manufacturer repeated the same mistake with the new electric VW flagship the I.D. 3 model. Delivery of the vehicle was postponed for several months for “software problems.” Again, the wheels were designed first without to consider if the “brain” can manage the correct supervision to the wheels.

The instant disclosure's philosophy is that a system controller must be holistic, and must be designed first, and the traction, steering, braking, running stability and energy management should be designed and built within the controller's management limitations. In other words: the brain comes before the wheels; and, after the transportation industry wasted 130-years with various piston engines, it should now continue developing where it started in the 1930s, in the direction of electric transportation with holistic controllers.

### Two Centuries of Precedent Railway-Vehicle Engineering

A railway-vehicle running along a track is one of the most complicated dynamic system in engineering. Many bodies comprise the system, and it has many degrees of freedom. The bodies that make up the vehicle can be connected in innumerable ways, and a moving interface connects the vehicle with the track. This interface involves a complex geometry of wheel-tread and railhead producing non-conservative frictional forces generated by relative motion in the relatively small contact patch in relation to the weight of the railway-vehicle. Strength of material and the rigidity of the components posed the paramount problem since dynamic loads applied to the track were of great concern.

From the earlier days of the railways—when John Blenkinsop built the first commercial locomotive in 1812, about 73-years before Carl Benz introduced the first automobile in 1885—to present, conventional solid wheelsets wear-out and assume a hollow form, while wearing out the rail. In any curve, these wheelsets curved with an angle of attack (FIG. 4) which made the wheelsets rely on their flanges to guide them around a curve. Yet, flange wear demands costly replacement to avoid further derailment. Creep (friction) forces play crucial role in determining the lateral dynamic performance of rail vehicles. Hunting (lateral stability), ride quality or lading-damage, wheel derailments, and wheel/rail wear are all directly affected by creep forces that occur in contact patches between the wheel and rail, particularly while managing rail-divergence with traditional fixed, extremely heavy axles.

As a proximate result, railway-vehicles with conventional solid wheelsets must utilize mammoth diesel engines, or 4-6-8-12 or 16 electric traction-motors, utilizing 6 MW to more than 10 MW electric-motors in combination with diesel ICE to overcome creep forces and other inefficiencies; in particular, the creep forces caused by many dozens of solid-axle wheelsets that were not-steered and dragged in articulated-cars. In the process, bigger electric traction-motors, and bigger diesel engines where manufactured and installed, with which railway companies consumed more electricity and diesel fuel than hundred thousand homes; and pollute the environment more than thousand trucks and semi-trailers: in particular, when running at high speed and when negotiating curved rails.

### Chronicles Of Wheelsets & Bogie Development

At launching of the first locomotive, it was no secret that traditional solid-axle wheelsets cannot achieve a fully radial position in a curve, as their yaw movement is restricted. It took locomotive engineers nearly two centuries to realize that propelling and steering each wheel independently would generate much better dynamic results than traditional solid-axle wheelset. The rationale was probably lack of today's electronic technologies and digital controls.

In an 1812 patent, William Chapman, and his brother Walton presented the first bogie where the leading wheelset was mounted rigidly in the locomotive-body and the trailing wheelsets mounted in a frame pivoted to the locomotive body. It was predicted that a proportion of the weight would be carried by the bogie through the conical wheels, so es to allow rotational freedom of the bogie relative to the locomotive body. Yet, this design is not ideal because the wheelset could not adopt a radial position on curves necessary for pure rolling of the vehicle. Therefore, the early bogies were designed with a truly short wheelbase in order to assist curving.

In the 1850s the bogie wheelbase was increased some, which improved stability significantly. Bissel's patented a 4-2-0 configuration of locomotive, which removed most geometric errors inherent in Chapman's design that attributed to many derailments. The bogie frame was pivoted to the locomotive frame at a center point between the driver and the midpoint of the bogie wheelbase, permitting the locomotive and the bogie to take-up more radial attitude in curves.

The increasing size of locomotive intensified the problem of the forces generated in negotiating curves. In 1883, Mackenzie introduced the first essentially correct description of curving. This became the basis of a standard calculations carried out in multiple designs throughout the steam locomotive era.

With the introduction of the all-electric locomotives in the end of the 19^{th} century, the first realistic model of lateral dynamics of a railway-vehicle was presented by Carter in 1916; a model of forces acting between wheel and rail, which proposed the first calculations of Hunting (lateral stability). Carter also introduced the fundamental concept of creep (friction) and concluded the effect of conical wheels. He showed that a combine effect of creep and conicity could lead to dynamic instability because the forces acting between wheels and rail can be assumed to be proportional to the creepage. The problem of guidance was resolved by almost universal adoption of the flanged wheel (FIG. 4) in the early 20^{th} century, which was the result of empirical development and dependent on engineering intuition.

Over the last three decades, railway-vehicle dynamic changed from following an essentially fundamental mechanical engineering discipline to one that is increasingly incorporating sensors, electronics, and computer processing. A great number of different designs of rail-vehicles is in the market, yet the structure of such vehicles commonly has a set of standard modules and mechanisms that are adapted by different manufacturers, and produced with different characteristics as chosen by their engineers, but the physical nature be that as it may, remains identical and is exclusively based on separate control of traction, steering, braking and running stability (FIG. 1), which results in imperfect traction, ill-functioning steering and unsafe braking in any bogie-configurations. Steering deficiencies were reduced by merely bringing the axles closer to each other while compromising stability, which led to widespread derailments.

In 1968, Joost Kalker gave a full solution of the general three-dimensional case covering arbitrary creepage and spin for case of dry friction and ideal elastic bodies contact and subsequently gave simpler approximate solution methods. The many works of Kalker have laid the groundwork for most steel-wheel/steel-rail creep force models. Kalker's theories range from the linear theory (creep force linearly proportional to creepage) to a simplified theory (tangential displacement difference proportional to a tangential traction) to the ‘exact’ numerical theories. The following equation is the linear approximations for the motion of a solid axle wheelset:

$$m y + 2 {f}_{22} ( \frac{y}{v} - ψ ) - F y - \frac{m {v}^{2}}{{R}_{0}} - mg θ = 0 , \\ J w ψ - 2 {f}_{22} ( \frac{y}{v} - ψ ) + 2 {f}_{33} \frac{ψ}{v} + 2 {f}_{11} ( \frac{{l}_{0}^{2} ψ}{v} + \frac{{l}_{0} λ y}{{r}_{0}} ) = 0 . \qquad Eq . 1$$

Where m is the wheelset mass, y the lateral movement, f₁₁ f₂₂ and f₃₃ are the Creep coefficients, v the wheelset speed, ψ the wheelset yaw movement, F_{χ} and F_{γ} are longitudinal and lateral creep forces, Ro the curve radius, θ the differential wheel rotation angle Jw wheelset yaw inertia, l₀ semi gauge, r₀ wheel radius, and), the conicity.

As locomotives became more powerful and consequently longer, the problem of steering on sharp curves, typical in railways in mountainous regions, became acute. In the middle of the 20th century, railway-vehicles speed continued to increase, and a greater potential risk of instability developed a more scientific approach to locomotive dynamics. A Swiss engineer, Roman Liechty gave valuable insight into design of vehicles for operation on the curvaceous rail-lines that were at the disposal of railway engineers in the 1930s. Liechty argued that a three-axles, connected by suitable linkages, would assume a radial position on curves and re-alien themselves correctly on straight track (FIG. 7). Liechty's designs were applied on several railways. Schwanck summarized Liechty's experience in 1974, who concluded that wheelset steering is one of the most effective means against flange and track-wear.

### Steering by Means of Active Primary Suspension

In conventional railway-vehicles, the front wheelset of the bogie produces large lateral creep forces while negotiating a curve. This poses a risk for derailment through flange climbing and the larger wheelset lateral force sets the limitation on the safe running speed of the vehicle (FIG. 4). The first conditions that must be satisfied for ideal curving is to equal and sufficiently balance the centripetal forces that the lateral creep forces produced by all wheelsets; and the second condition for ideal curving is to bring longitudinal creep forces produced by the wheelsets to zero, as indicative of minimal wheel slip.

There are six leading configurations in the current market, designed to control the lateral and yaw methods of running gears to enhance stability and curving performance. Six concepts of active primary suspensions are divided into three Solid-axle wheelset models, and three independent rotating wheels models:

### (i) Actuated Solid-Axle Wheelset (ASW)

ASW is most extensively studied configuration where either yaw torque or lateral force is applied directly to the wheelset to control the yaw and lateral motions so that curve negotiation and stability improves. This principle can be realized by three mechanical arrangements. FIG. 5 embodies the mechanical arrangements for actuated solid-axle wheelset (ASW). Yaw torque could be applied directly by one yaw actuator mounted between bogie frame and wheelset as shown in FIG. 5A or in a more practical way utilizing two actuators in the longitudinal direction at the ends of the wheelset, as indicated in FIG. 5B. Since wheelset yaw motion and lateral motion are coupled, implementing lateral actuators is another way to achieve the motion control of the wheelset FIG. 5C. Based on a simplified two-axle bogie model concluded that lateral actuation requires a larger force to achieve the same stability of the vehicle than the yaw actuator.

### (ii) Secondary Yaw Control (SYC)

Yaw torque from car-body to bogie is produced by two longitudinal electro-mechanical-actuators in the position where the original passive yaw damper is mounted. A schematic of this concept is shown in FIG. 6. The SYC concept enhances the vehicle critical speed and reduce track shift forces. Since the motion of the wheelset is uncontrolled, the steering effect is not as effective as ASW, but the improved stability can allow lower primary yaw stiffness and consequently lead to an improvement of the curving performance. Although it is reasonable as well to classify the SYC into active secondary suspension, the target of SYC is to improve stability and reduce track sheer forces in curves rather than improving ride quality. Therefore, this control scheme is closer to the nature of active primary suspension.

### (iii) Actuated Yaw Force Steered Bogie (AY-FS)

This concept can significantly improve the curving behaviour of locomotives with high tractive effort. Based on Secondary Yaw Control (SYC), Simson proposed a new active suspension AY-FS for heavy hauling locomotives. In his concept, force steering linkage is implemented with SYC. It can be seen as a combination of SYC and passive steering linkages through which wheelsets can be forced into an ideal position according to the kinematic relationship between bogie and car-body (FIG. 7).

### First, Partial Integration of Traction & Steering

Apart from implementing Active Primary Suspension (APS) in solid-axle wheelsets, Independently Rotating Wheels (IRW) is another solution to overcome the notorious trade-off problem between running stability and curving performance. Compared to solid-axle wheelsets, a change in the wheelset configuration enables opposing wheels on the same axle to independently rotate with respect to each other. In this way, the dependency between the yaw and lateral movement of the wheelset is removed, virtually eliminating the longitudinal creep force at the wheel-rail interface. Thus, pure rolling is no more dependent on the lateral position of the wheelset, which significantly reduces wear and inhibits hunting motion.

IRW equations are remarkably similar to Kalker's linear approximations for the motion of a solid axle wheelset but, the additional differential angle of rotation θ since during turning modes the IRW models represent different angle on each wheel as follows:

$$m y + 2 {f}_{22} ( \frac{y}{v} - ψ ) - \frac{m {v}^{2}}{{R}_{0}} - m g θ - F y = 0 , \\ J w ψ - 2 {f}_{11} ( \frac{{l}_{0}^{2} ψ}{v} + \frac{{l}_{0} λ y}{{r}_{0}} + \frac{{l}_{0} {r}_{0}}{v} θ + \frac{{l}_{0}^{2}}{{R}_{0}} ) - T w = 0 , \\ {J}_{0} θ - ( λ y - \frac{{l}_{0} λ y}{v} ψ - \frac{{r}_{0}^{2}}{v} θ - \frac{{l}_{0} {r}_{0}}{{R}^{0}} ) = 0 . \qquad Eq . 2$$

Where m is the wheelset mass, y the lateral movement, f₁₁ and f₂₂ are the Creep Coefficients, v the wheelset speed, ψ the wheelset yaw movement, F_{γ} is the lateral creep forces, Ro the curve radius, θ the differential wheel rotation angle, Jw wheelset yaw inertia, l₀ semi gauge, r₀ wheel radius, γ the conicity, and Tw the yaw torque.

### (iv) Actuated Independently Rotating Wheelset (AIRW)

The concept of AIRWs is based on the possibility of controlling the yaw and lateral displacement of the common axle on which the independently rotating wheels are mounted with an external actuator. This can be done either by direct application of torque to the axle or use of a linear actuator (FIG. 8). The torque required to steer the AIRW is much lower than the one required by a solid-axle vehicle due to the nearly zero longitudinal creep forces. Achieving kinematic stability is no longer a problem with IRW so a strategy to provide either ‘steering’ or ‘guidance’ is required. The combined use of AIRW and DIRW strategies have been implemented to improve steering performances which is suitable for high speed and long-distance application with conventional bogie features. Such active system consists of one steering actuator and one electric traction-motor for each wheel.

### (v) Driven Independently Rotating Wheelset (DIRW)

The concept of DIRWs (FIG. 10) is based on the option to control the speed of the two opposing wheels of one axle autonomously, an option not available in solid axle. This is done by applying advanced asynchronous induction motor control methods to provide traction, wheel guidance and stability control. The electric traction-motor can be (a) embedded inside the wheels or (b) mount on the bogie externally, or (c) connected to the wheel through a gearbox. However, the steering approach of IRW induction motors build inside the wheel includes more detriments than benefits:
(1) Electric motor inside the wheel lacks the benefit of increasing torque because this ‘direct-drive’ design has no gears to boost e-motor torque, which is a must in locomotives where at least 200 kN starting tractive-power is required.
(2) A large electric motor requires a large cooling system. A 1,250 mm in diameter locomotive cast-iron wheel creates an extremely hot environment through steady lateral and longitudinal creep forces; and especially during braking procedure. The extreme hot environment will cause frequent brake-downs and short-lived e-motors.

### (vi) Directly Steered Wheels (DSW)

The concept of DSW (FIG. 10) involves the total removal of the common axle between opposing wheels and is replaced by a frame on which each wheel is mounted, and connected by a track rod, with which the two wheels can be steered. Controlling the speed of the motors creates an electronic axle and makes the wheelsets suffer from all the problems of a solid-axle wheelset including kinematic instability. Actuation is provided by applying a displacement to steering-rod 2 as shown in FIG. 10 or by applying a differential torque through hub-mounted traction-motors. Torque controlled motors, however, only affect the rotational acceleration of the wheels, which causes them to have different angular positions and therefore the electric-motors does not behave like a solid-axle wheelset. The control could again be aimed towards active steering.

Taking everything into account: In all forms of active steering, any independently rotating wheels (IRW) show the best performance with a significant reduction in wear on straight, and above all, in a curved track. In the ASW and SYC arrangements, the control action interferes with the natural behavior of a solid-axle wheelset which requires a higher actuation effort and is also detrimental to the wheel-rail wear. During curving, both solid-axle wheelset and IRW have their own separate merits and demerits. In case of solid-axle wheelset, passive suspension severely affects the curving performances, whereas IRW has problem in guidance control both in straight and curve track, but no issue with stability.

### BRIEF DESCRIPTION OF THE INVENTION

This application discloses a configuration of scalable traction, integrated in the steering and in the braking systems, for locomotives and for articulated cars, which put together one efficient system that accomplishes a comprehensive traction, steering and braking under the management of a holistic controller (FIG. 1) and at one go, carries out an outstanding vehicle dynamic, while dramatically reduces energy consumption, and wheel and rail replacement expenditures.

The paramount objectives of this disclosure are to solve virtually all economic and environmental challenges before railway companies today:
(a) meet current government pollution and safety standards.
(b) reduce the mammoth consumption of electricity.
(c) abolish use of diesel fuel and any mineral oil products.
(d) utilize alternative energy sources when overhead receptivity is not available; and
(e) diminish the enormous expenditures of wheels and rail deterioration.

Whereas the majority of patents comprise ‘one device does it all,’ the solutions to the five challenges above, cannot be resolved with just one device. This application discloses a variety of devices and sensors installed along the railway-vehicle.

This discloses is a radical configuration of independently rotating wheels (IRW), comprising plurality of differently designed electric traction-motors that perform over and above as just tractive-power provider since plurality of differently designed electric traction-motors are involved in the traction, the steering and in the braking procedures. Multiplicity of electric traction-motors in the traction, the steering, and the braking systems is meant to create better precision, to assist, and secure a balanced power in the locomotive and along 12 to 18 more or less articulated cars, whereas managing the long railway-vehicle as one piece to achieve an outstanding handling, and virtually 100% dynamic efficiency. Having the traction, steering, and braking systems exclusively in the locomotive, while dragging 12 or 18 articulated wagons with over 150 wheels through a curve without to steer them, and without to create a balance deceleration to a stop, will never solve the five challenges before the railway companies listed in supra.

Efficiency of electric traction-motors is usually load dependent and is best at about 70 to 80% of full load. As the load on a motor drops from full load to less than 50%, the motor efficiency begins to plunge, and it drops to 40% when the load is only 10-15%. The efficiency of electric traction-motors increases with increase of the rotational speed (FIG. 23, a), until the peak efficiency is reached (FIG. 23, b). If the speed is further increased after point b, the efficiency begins to decrease dramatically (FIG. 23, c). However, it is incorrectly accepted as true that a motor that is turned off, consumes no energy because cutting off the power supply while the motor is still connected to the wheel[s], converts the electric motor into a generator. This phenomenon is exploited in regenerative braking to stop the railway-vehicle whereas converting the railway-vehicle massive kinetic energy into electric energy, which is discussed in particulars infra. Merely cutting off the power to the electric traction-motors without to disconnect it from the wheel[s] is certainly not the way to get better efficiencies. A parallel scenario was the failed General Motors' 4-6-8 engine experience in the 1970s. The notion was based on cutting off the ignition and fuel supply to 2 or 4 cylinders out of 8 should consume less fuel. Yet, the unpowered 2 or 4 pistons and all related parts continue to move with the crankshaft. The ‘additional’ friction of multiple parts was not taken seriously into considerations, which diminished the expected fuel savings.

There are infinite, pragmatic approaches to design electric traction-motors and their electronic controls to improve efficiency; from diversity of single-phase to high accuracy poly-phase approach, managed with electronic devices, as ‘vector control’ and ‘advanced driver control,’ to enhance efficiency:
(i) Vector control, known as field-oriented control (FOC) utilizes two orthogonal components; one defines the magnetic flux in the stator, providing the controller with the magnetic flux data for the field-oriented control algorithms; whereas the other corresponds to the torque as determined by the rotor position and speed, in a loop with a speed sensors.
(ii) Driver control is in principle a variable frequency drive (VFD) motor controller that drives an AC induction motor (ACIM) or permanent magnet synchronous motor (PMSM) by varying frequency and amplitude of the current supplied to the motor.
Both precision electronic controls may improve efficiency by 10% to 15%, yet they cannot overcome the physical limitations of electric motors, such as exceptionally low efficiency in low and high speed, and in low and high load conditions. FOC and VFD swayed EV and locomotive manufacturer that one e-motor should be sufficient to propel an EV, and four or six identical, huge electric traction-motors should be sufficient to propel a 350-meter-long railway-vehicle. The question is why EVs' average traveled-distance per charge is only 200 Km [with 50 kWh battery-pack]? And why railway-vehicles continue to consume gigantic amount of electricity?

Nature's motoric is intricate, extremely efficient, and multifaceted process, comprising plurality of muscles with different histology ‘configurations,’ controlled by electric current, chemical reactions, electrolytes, and hormones. It is notorious that humans riding a bicycle is the most efficient ‘machine’ to get from point A to point B. However, there is one setback nature did not find a solution yet. Most groups of muscles are organized with counter muscle-groups. For instance, to make a plain forward step, the three anterior (front) major muscles in the thigh are the pectineus, sartorius and quadriceps femoris that lift the upper leg to make the initial forward step. Simultaneously, the posterior (back) muscles of the thigh: semitendinosus, biceps femoris, and the gluteus muscles have got to be stretched to allow the forward movement. This stretching act reduces the efficiency of the front muscles because it requires additional energy to overcome the back-muscles resistance.

This application discloses a configuration with field-oriented control (FOC), and with variable frequency drive (VFD) motor controls as basic power management of the electric traction-motors. Yet, this disclosure supersedes all available ‘efficiency electronic solutions,’ including nature's unrivaled efficiency as discussed supra. To achieve this objective, two-stage technology are shaped just for the efficiency of the traction system:
(i) a railway-vehicle is configured with plurality of electric traction-motors [depending on the length of the railway-vehicle and the load carried], installed in the locomotive and in selected articulated cars. The electric traction-motors are configured in several groups of differently designed electric traction-motors to accomplish continuous, efficient traction above 90%, from starting tractive-efforts to the top-rated speed of the railway-vehicle. Each group is designed to operate above 90% efficiency in a specific, yet different speed-ranges (FIG. 24). Controller 100 may couple and de-couple specific electric traction-motor groups to overlap the efficiency range of the group before with the group after, which creates a continuous 90% efficient traction.
(ii) the scalable motor control in this disclosure is realized by coupling specific electric traction-motors to the wheels when the railway-vehicle reach the speed and the load where the coupled electric traction-motors are design to operate above 90% efficiency rate. When the railway-vehicle velocity increases and reach the efficiency-limits of the coupled electric traction-motor group, controller 100 first couples the next electric traction-motor group with a higher efficiency range of operation that starts just before the coupled electric traction-motor group efficiency-range ends, and then, controller 100 de-couples the previously coupled electric traction-motor group from the wheels.
This part of the disclosure supersedes the 10-15% efficiency added by vector control (field-oriented control, FOC); and supersedes nature's deficiency as well because the human body does not have the ability to ‘disconnect’ muscles to save energy.

The majority of electric traction-motors may have electronic-clutches as a feature, to couple and de-couple the electric traction-motors from the wheels in particular speed and load condition, whenever controller 100 algorithms indicates that less than all electric traction-motors are necessary to maintain specific instant load and speed. Physical de-coupling of electric traction-motors from the wheels may contributes 40% and more reduction in energy consumption, depending on the load, the speed, and the topographic circumstance.

In addition, the instant disclosure is configured with differently designed plurality of electric steering-motors, installed in the center of each bogie in the locomotive and in bogies along all articulated cars. All wheels in the railway-vehicle are independently rotating (IRW) with no solid axle configurations. All wheels are steered to virtually pull off 100% dynamic efficiency. However, traction and braking systems may be installed in less than all wheels of articulated cars; all of which is intended to establish the following upgrades:
(i) Allocation of plurality electric traction-motors with digital management solutions to replace inefficient traditional solid axle wheelset in locomotives and articulated cars.
(ii) Utilizing only electric traction-motors [dispose of systems with mineral oils as hydraulic brakes system] to meet government pollution standard.
(iii) Reach an effective reduction in creep (friction) forces, which has a crucial role in affecting efficiency, and the lateral dynamic performance of rail-vehicles.
(iv) Affording better hunting (lateral stability), which plays a crucial role in affecting ride quality or lading damage, wheel climb derailments, and wheel/rail wear, all of which are directly affected by creep forces that occur in the contact patch between wheel and rail, particularly while managing rail-divergence.
(v) Diminishing drag-forces by steering all wheels along the railway-vehicle.
(vi) Massive reduction in wear of wheels and rail due to considerable reduction in creep forces through perfect alignment of the wheels in straight and curved tracks.
(vii) Dramatic reduction of derailments.
(viii) Significant reduction in grinding noise particularly during rail-divergence and elimination of sinusoidal oscillation in passenger wagons.
(ix) Better efficiency due to no wheel-dragging, which results as highly effective reduction in pollutant output; and
(x) Massive reduction in electricity consumption for same distance traveled, under equivalent load and speed conditions.

It is perceptible that improving efficiency cures to certain degree all five challenges before railway companies as defined supra, and therefore, efficiency is the paramount goal of this disclosure. However, since the wheels in a locomotive and in articulated-cars are an ‘end producer’ of traction, steering and braking, this application discloses a concept that is not associated with inventing distinctive wheels but concentrating in the design of holistic controller, in the design of sensors, electric traction-motor clutches and devices connected to the controller to provide precise electric power distribution to differently designed electric traction-motor; steer each wheel in a loop with the controller, the steering-motor and the respective yaw-sensors, and to ensure balanced braking from the front locomotive axle to the last articulated car axle, to avoid the widespread “run-in” and “run-out” scenarios.

In braking modes, controller 100 is programmed to first slow-down the wheels with all or less than all traction-motors [acting as generators]—to prevent a “run-in” or “run-out” scenarios—while generating electric energy. The final stop is achieved with plurality of electric-disc-brake calipers (FIG. 1, #8 shows only one) installed in the locomotive and in selected articulated cars.

The most important aspect of this disclosure is first the evaluation of two centuries old railway engineering concepts that were exclusively developed at the mercy of cheap coal and cheap oil, whereas the engineering approach was based exclusively on mechanical, inefficient and heavy polluting elements in the traction system, ill-operating steering, unsafe hydraulic brake-system, with no coordination between the three systems, and no controls whatsoever in a 350-meter-long articulated cars with more than 70 not-steered solid-axle wheelsets.

By way of emulating nature ‘technologies,’ this disclosure managed to radically improve all traditional systems in a railway-vehicle with a single, holistic controller. The majority of wheels, including elected wheels in articulated cars, are individually propelled, under sophisticated scalable power-control system, which eliminates wasteful energy use-up. In this ‘all-wheel steering’ disclosure, every 1, 2 or 3 axle bogie configurations along the railway-vehicle is configured with 2, 4 or 6 wheels respectively, are steered as a group by a single steering-motor in a digital loop with the holistic controller, which is continuously informed of the instant wheels-position, while maintaining a loop with a single yaw-sensor in each bogie (FIGS. 11b, 12b, 13b, 14b and 15b).

Likewise, the instant disclosure replaces the traditional hydraulic braking-system with state-of-the-art electric, digitally controlled braking-system, comprising [relative to the weight of the railway-vehicle] small electric-calipers, due to the integration of electric traction-motors in the complex fast-deceleration and the coordinated final stop of all articulated cars. The instant disclosure further replaced the traditional articulated cars couplers with an electronic-couplers, that monitors the instant ‘free-slack’ between articulated cars. A contact-less sensor continuously monitors the changing distance between all articulated cars and transmit the information to the controller, wherein a Multi-objective Optimization Design (MOOD) procedures is utilized to activate the electric traction-motors and the electric brake-calipers in a specific sequence to keep a manageable ‘free-slack’ between articulated cars and eliminate a ‘run-in’ and ‘run-out’ scenarios. Attributable to all those improvements, the railway-vehicle may drop about 30% of its traditional weight; energy consumption may be reduced by more than 50%; and repair and maintenance expenditures are estimated to decline by 400%. A completely different animal.

### BRIEF DESCRIPTION OF THE DRAWINGS

The drawings illustrate embodiment presently contemplated for carrying out the invention. It is imperative to clarify that all axle-boxes are drawn as if they are an integral part of the bogie frame, which is not the actual condition. Axle-boxes are an integral part of a bogie primary suspension, located under the bogie frame; however, a bogie view from the top would camouflage the axle-boxes, and therefore, a viewer should take it into consideration. In the drawings:

FIG. 1 depicts system 10 partial wiring in a locomotive Co'Co'bogie configuration along with partial wiring to articulated coach-cars with independent rotating wheels (IRW) configuration, forced steering and a representative of an coach-cars with electric traction-motors. 01 is the locomotive traction-transformer, and 02 the traction-transformer for the coach-cars equipped with electric traction-motors; 8 is an electric brake-caliper; 9 is a yaw-sensor in the front bogie; 10 is an electromagnetic sensor-array in the front of the locomotive; 11 and 12 are single-phase voltage source type pulse width modulation (PWM) rectifier; 13 represents a GPS sensor and receiver; 14 represent a battery-pack connected to electric traction-motors 53, 54 in the middle of the front bogie, and 15 represent a battery-pack connected to electric traction-motors 51 and 52 in the front of the bogie, and 55 and 56 in the rear of the bogie; 16 is a ultra-capacitor pack connected to electric traction-motors 53 and 54 in the middle of the front bogie, and 17 is a ultra-capacitor pack connected to electric traction-motors 51 and 52 in the front of the bogie, and 55 and 56 in the rear of the bogie; 18 is a locomotive engineer's speed-control lever, and 19 is a braking control lever; 20 presents a locomotive instant velocity; 21 is a Bi-Directional DC/DC converter connected to a DC/AC, 3-phase inverter 42 that supplies power to electric traction-motors 53 and 54 in the middle of the front bogie; 22 is a Bi-Directional DC/DC converter connected to DC/AC, 3-phase inverter 44 that supplies power to electric traction-motors 51 and 52 in the front of the bogie, and 55 and 56 in the rear of the bogie; 23 is a large steering-screw; 24 is a steering-rod; 25 is a large steering-motor; 26 is a tie-rod; 30, battery-pack sensor for storage unit 15; 31 is a ultra-capacitor sensor for storage unit 17; 32 is a DC Bus connected between DC/DC converter 22 and DC/AC inverters 46 and 48; 33 is a DC Bus connected between DC/DC converter 21 and DC/AC inverters 42 and 44; 34 is a controller direct connection to bi-directional DC/DC converters 21; 35 is a voltage sensor of bi-directional DC/DC converters 21; 36 is a voltage sensor of bi-directional DC/DC converters 22; 37 is a controller direct connection to bi-directional DC/DC converters 22; 38 is a battery-pack sensor for storage unit 14; 39 is a ultra-capacitor sensor for storage unit 16; 42 is a bi-directional DC/AC inverter 43 is the wire connection between DC/AC inverters 46, 48 and DC/DC converter 22; 44 is a bi-directional DC/AC inverter; 45 is the wire connection between DC/AC inverters 42, 44 and DC/DC converter 21; 46 is a bi-directional DC/AC inverter; 48 is a bi-directional DC/AC inverter; 49a are 4 wires running from the controller to DC/Ac inverters 42, 44, 46 and 48; 49b are 4 wires running from the controller to DC/Ac inverters in the rear bogie [not shown]; 61 is a shaft of an electric traction-motor [with clutch]; 62 is a shaft of an electric traction-motor [without clutch]; 65 is a wheel-axle gear; 66 is a large electric traction-motor [without clutch] shaft gear; 67 is a wheel-axle gear; 70 is a large steering-ball; 76 is a secondary suspension; 90 is a disc-brake fixed to the wheel; 119 is an electronic coupler between wagons 113 and 114, configured with a hall-effect sensor, instantly monitoring the distance between wagons 113 and 114.

FIG. 2 depicts two independent systems, which characterize a traditional concept of vehicle manufacturing—propulsion is one system, steering is an isolated system, and braking is a separate system, with no interaction between the three systems. The first typically propels only the locomotive wheels, the second usually steers only the locomotive wheels, and the third stops only the locomotive wheels. There is no bringing together between the three systems. The braking system is totally independent with no mechanical or electronic connection with any other system whatsoever.

FIG. 3 depicts the fundamental concept of the instant disclosure, namely, a balanced differentiation and integration between traction, steering and braking to realize virtually 100% vehicle traction and dynamic efficiency.

FIG. 4 represents the traditional solid-axle wheelset angle-of-attack a, while entering a curved rail.

FIGS. 5 through 10 are six different concepts of railway-vehicle steering, which are currently installed in railway-vehicles. There are three different mechanical arrangements for actuated solid-axle wheelset (ASW):
FIG. 5A Yaw torque is applied directly by one yaw actuator mounted between a bogie frame and the wheelset; FIG. 5B Yaw torque is applied by two actuators in the longitudinal direction at each ends of the wheelset; FIG. 5C Implements lateral actuators to achieve motion control of the wheelset. 1 represents a steering actuator; 2 represents a wheel-axle; and 3 the bogie frame.

FIG. 6 is a Secondary Yaw Control (SYC) configuration, where the actuators provide a controllable yaw torque to the bogie from the vehicle frame. 1 represents a steering actuators; 2 represents a wheel-axle; 3 a bogie frame, and 4, a locomotive frame.

FIG. 7 is an Actuated Yaw Force Steered (AY-FS) in a Co'Co'bogie configuration, which looks like a combination of SYC and passive steering linkages through 3 wheelsets that can be forced into an ideal position according to the kinematic relationship between bogie and car-body. 1 represents a steering actuator inside the bogie; 2 represents a three-wheel-axle; 3 a bogie frame, and 4 additional two steering actuator, attached between the bogie and the locomotive frame.

FIG. 8 represents an actuated independently rotating wheel (AIRW) configuration. The actuators provide a controllable yaw torque from bogie to independently rotating wheelsets. 1 is a four independent steering actuators from the bogie frame to an extension outside the wheel. 2 represents a common axle of two opposing independently rotating wheels, and 3 represents a bogie frame.

FIG. 9 represents an electric traction-motor active steering control direct-drive configuration in a IRW system. 9A represents a bogie with a motor direct-drive IRW, and 9B represents an active steering control based on the speed and torque differences between the left and the right wheels where the rotor is directly connected to the IRW. 1 & 2 are the traction-motors that are installed inside or outside the bogie, respectively; 3 is a controller that sends different speed and torque commands to oppose electric traction-motors.

FIG. 10 is a basic directly steered wheels (DSW) configuration. Actuation is provided by applying a displacement to the steering-rod (2) or by applying a differential torque and speed, through hub-mounted traction-motors. 1 is an independently rotating wheel's frame; 2 is a steering track rod; and 3 is a Bo'Bo'bogie frame.

FIGS. 11A through 15C are plurality of different bogie configurations in the instant disclosure and the components layout in different configuration of steerable single-axle, two-axles, and three-axles bogie wheelsets with different electric traction-motors, without electric traction-motors and with one axle with electric traction-motors and the other axle without electric traction-motors.

FIG. 11A is a side-view and top-view of a single axle steerable wheelset layout; installed in under-and above ground city railway-vehicles, predominantly in passenger wagons.

FIG. 11B is a single axle configuration, moving on a straight track. Where 9 represents a yaw-sensor; 23 a large steering-screw; 24 a steering-rod; 25 a steering-motor; 26 a tie-rod; 27 a steering-screw ball-bearing; 28 a steering-screw head; 63 a wheel-shaft and steering-ball bearing; 70 a large steering-ball is inside an axle-box 71, where a wheel-axle end is embedded inside a large steering-ball; 72 is a long spur- or helical-geared steering-column; 73 is a complete steering-aggregate without electric traction-motor; 75 a primary-suspension; 76 a secondary-suspension; and 90 a disc-brake incorporated into a wheel.

FIG. 11C is a single axle configuration, moving on a curved track. The drawing demonstrates the movement of all steering parts as numbered in FIG. 11b.

FIG. 12A is a two-axle traction and steerable, Bo'Bo'bogie configuration with two pairs of Independent Rotating Wheels (IRW), one pair is configured with large electric traction-motors yet, without clutches, and the other pair is configured with two medium-size IRW electric traction-motors equipped with electric-clutches; usually installed in locomotives, and in articulated-cars, including under-and above ground city railway-vehicles, in locomotives and in passenger wagons.

FIG. 12B is a two-axle Bo'Bo'bogie configuration, moving on a straight track. Where 9 is a yaw-sensor; 23 a large steering-screw; 24 a steering-rod; 25 a steering-motor; 26 two tie-rods; 27 a steering-screw ball-bearing; 28 a steering-screw head; 63 a wheel-axle with ball-bearings; 70 a large steering-ball inside an axle-box 71, 72 are two long column configured as spur- or helical-gears, 75 is a primary-suspension; 76 is a secondary-suspension; 88a a large electric traction-motor RPM-sensor; 88b a RPM-sensor monitoring the speed of a medium-size electric traction-motor disc-clutch; 88c a RPM-sensor monitoring the speed of the wheel-side disc-clutch; and 90 is a wheel disc-brake fixed to the wheel.

FIG. 12C is a two-axle steerable, Bo'Bo'bogie configuration with two large electric traction-motors without clutches, and two medium-size electric traction-motors with electric-clutches moving on a curved track. The drawing demonstrates the movement of all steering parts as numbered in FIG. 12B.

FIG. 13A is a two-axle steerable Bo'Bo'bogie, configured with two medium-size electric traction-motors equipped with electric clutches, and configured as independently rotating wheels (IRW). The other steerable-axle comprises two steering-aggregate without electric traction-motors; predominantly installed in articulated power-cars in under-and above ground city railway-vehicles, and in passenger articulated wagons.

FIG. 13B is a two-axle Bo'Bo'bogie configuration. One axle is configured with two electric traction-motors, and the other axle is configured with two steering aggregates, moving on a straight track, where 9 is a yaw-sensor; 23 a large steering-screw; 24 a two steering-rod; 25 a steering-motor; 26 two tie-rods; 27 a large steering-screw ball-bearing; 28 a steering-screw head; 63 a wheel-axle with large ball-bearings; 70 a large steering-ball inside an axle-box 71; 72 two spur- or helical-gears configured as a long columns; 73 two steering-aggregates; 75 a primary-suspension; 76 a secondary-suspension; 88b RPM-sensor monitoring the speed of the electric traction-motor side disc-clutch; 88c RPM-sensor monitoring the speed of the wheel-side disc-clutch; and 90 represent disc-brakes on all four wheels.

FIG. 13C is a two-axle steerable, Bo'Bo'bogie configuration with two medium-size electric traction-motors, equipped with clutches, and two steering-aggregates without electric traction-motors, moving on a curved track. The drawing demonstrates the movement of all steering parts as numbered in FIG. 13B.

FIG. 14A is a two-axle only steerable, Bo'Bo'bogie configuration without electric traction-motors yet, equipped with four steering-aggregate 73. This bogie design is typically installed in passenger articulated-cars, commercial and freight railway-vehicles, including under- and above ground city railway-vehicles.

FIG. 14B is a two-axle B₀'B₀'bogie configuration with four steering aggregates, moving on a straight track, where 9 is a yaw-sensor; 23 a large ball-bearing steering-screw; 24 two steering-rod; 25 a steering-motor; 26 two tie-rods; 27 a steering-screw ball-bearing; 28 two steering-screw heads; 63 a wheel-shaft with large ball-bearing; 70 a steering-ball; 71 an axle-box; 72 two spur- or helical-geared configured as long steering-columns; 73 four steering-aggregates; 75 a primary-suspension; 76 a secondary-suspension; and 90 disc-brake fixed to the wheel.

FIG. 14C represent configuration of two-axle steerable, Bo'Bo'bogie with four steering-aggregates moving on a curved track. The drawing demonstrates the movement of all steering parts as numbered in FIG. 14B.

FIG. 15A is a large three-axle, Co'Co'bogie configuration with six electric traction-motors, equipped with intricate mechanism to steer all six wheels with just one steering-motor. This bogie design is typically installed in a locomotives of long-distance passenger, commercial and freight railway-vehicles.

FIG. 15B is a three-axle Co'Co'bogie configuration. The center axle is configured with two large electric traction-motors without electronic-clutches, and the other two axles may configured two pairs of differently designed, medium-size electric traction-motors with electronic-clutches, moving on a straight track; where: 9 is a yaw-sensor; 23 a large steering-screw; 24 two steering-rods; 25 a steering-motor; 26 two tie-rods; 27 a steering-screw ball-bearing; 28 two steering-screw heads; 61 is a shafts in all four electric traction-motors with electronic-clutches; 62 is a shafts for the two electric traction-motors without electronic-clutches; 63 a wheel-axle with ball-bearing for the front and the rear axles; 64 is an axle for all six wheels; 65 is a wheel-axle gear for all six electric traction-motors; 66 is a gear in all six electric traction-motor shafts; 70 are four large steering-balls in a front and a rear axle; 71 are four axle-boxes for a front and a rear axle; 72 two spur- or helical-gears in a long steering-columns for a front and a rear axle; 74 are two axle-boxes for a center axle; 75 a primary-suspension; 76 a secondary-suspension; 88a RPM-sensor monitoring the speed of the center electric traction-motor; 88b are four RPM-sensor monitoring the speed of an electric traction-motor side disc-clutch for a front and a rear axle; 88c four RPM-sensors monitoring the speed of a wheel-side disc-clutches for a front and a rear axles; and 90 is a wheel disc-brake fixed to all six wheels.

FIG. 15C represents the configuration of a three-axle steerable, Co'Co'bogie with six steerable electric traction-motors-wheel-aggregates moving on a curved track. The drawing demonstrates all steering parts as numbered in FIG. 15B.

FIG. 16 is in depth cross-section of a steerable, large electric traction-motor without a clutch, where: 62 is an electric traction-motor shaft; 63 a wheel-axle with ball-bearing; 64 a wheel-axle; 65 a wheel-axle gear; 66 an electric traction-motor shafts gear; 70 a large steering-ball inside axle-box 71; 72 a spur- or helical-gear, configured as a long steering-columns; 75 a primary-suspension; 88a RPM-sensor monitoring the speed of a center electric traction-motor; and 90 is a wheel disc-brake fixed to all six wheels.

FIG. 17 is in depth cross-section of a steerable, medium-size electric traction-motor with electronic-clutch, where: 61 is an electric traction-motor shaft; 63 is a wheel-axle with large ball-bearings inside a large steering-ball 70; 64 a wheel-axle; 65 a spur- or helical-gear on the wheel-axle; 66 is an electric traction-motor shaft spur- or helical-gear; 70 a wheel-axle steering-ball inside an axle-box 71; 72 is long spur- or helical-gear steering-columns; 75 is a primary-suspension; 83a a clutch release solenoid; 83b a clutch retrieving solenoid; 84 an electronic-clutch circular gear; 85 a large coupling-spring for the electric traction-motor side disc-clutch; 86 a wheel-side clutch-disc; 87 an electric traction-motor side disc-clutch; 88b a RPM-sensor monitoring revolutions of the electric traction-motor side disc-clutch; 88c a RPM-sensor monitoring revolutions of the wheel-side disc-clutch; and 90 wheel's disc-brake fixed to the wheel.

FIG. 18 is a detailed section of the clutch assembly in FIG. 17, configured with an electronic electronic-clutch assembly with six electromagnetic-solenoids where: 61 is an electric traction-motor shaft; 63a is a bearing in the rear of the electric traction-motor shaft; 63b is a large-size bearing in the rear of the electric traction-motor disc-clutch neck; 83a a solenoid that releases the electric traction-motor disc-clutch; 83b a solenoid that retrieves the electric traction-motor disc-clutch; 84 the rear of the electric traction-motor disc-clutch cylinder; 86 an electric traction-motor disc-clutch pull assembly; and 72 a spur- or helical-gear as a long steering-column configured between two electric traction-motors;

FIG. 19A is a steering aggregate in a Bo'Bo'bogie configuration where: 9 a yaw-sensor; 23 a large steering-screw; 24 are two steering-rods; 25 a steering-motor; 26 are two tie-rods; 27 a steering-screw ball-bearing; 28 are two steering-screw heads; 63 a wheel-shaft with ball-bearings; 70 are four, large wheel-axle steering-balls; 71 are four axle-boxes; 72 are two long steering-columns with a spur- or helical-gears; 75 is the primary-suspensions;

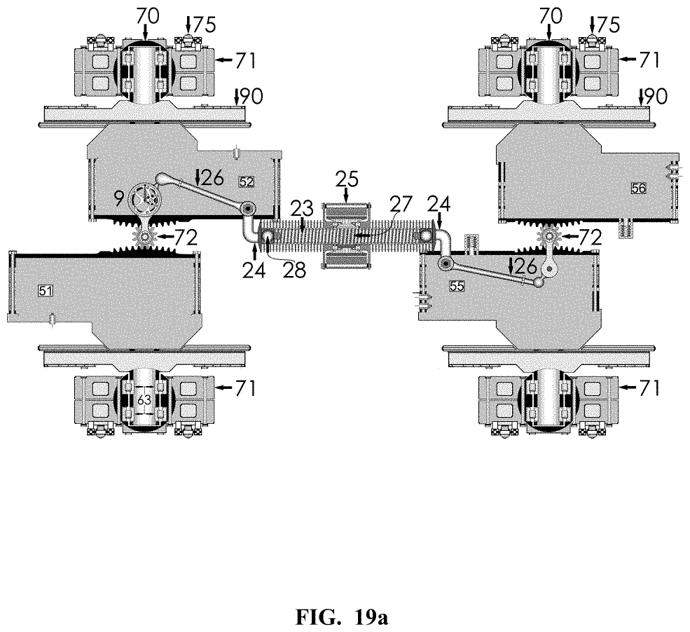

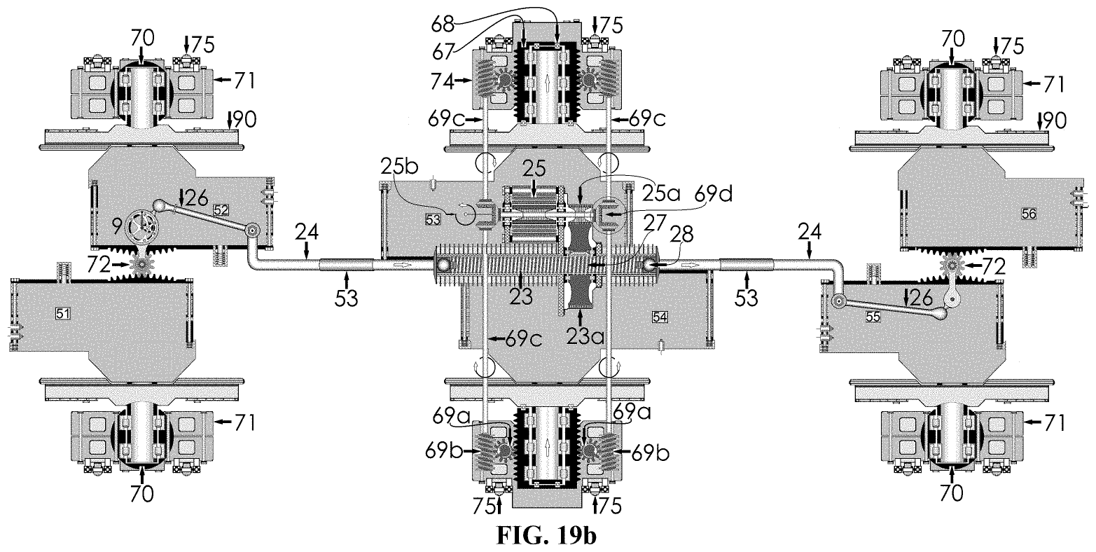

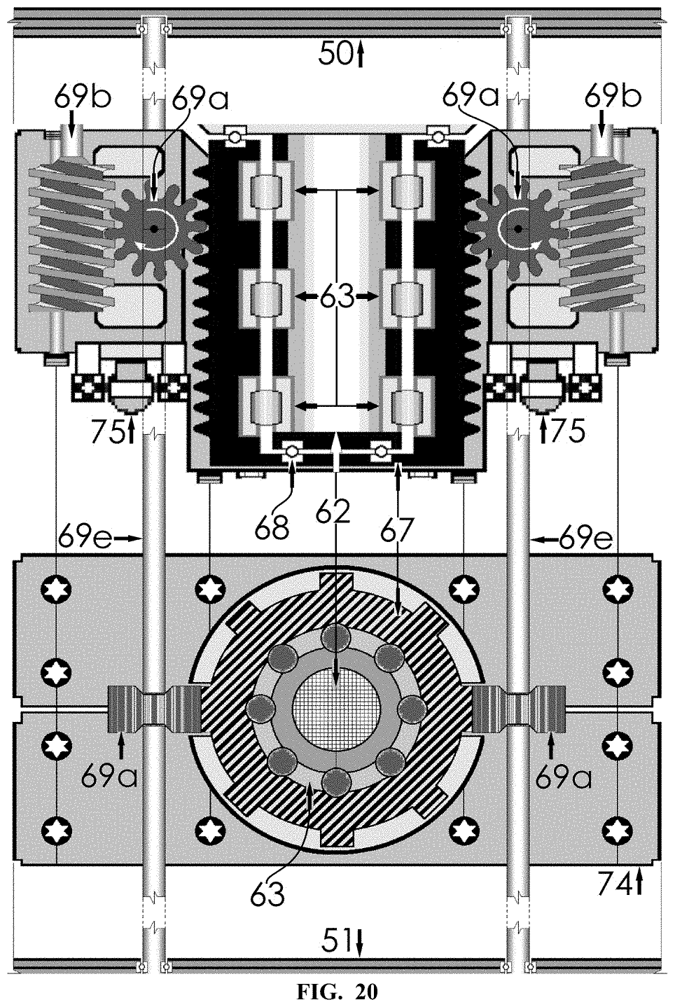

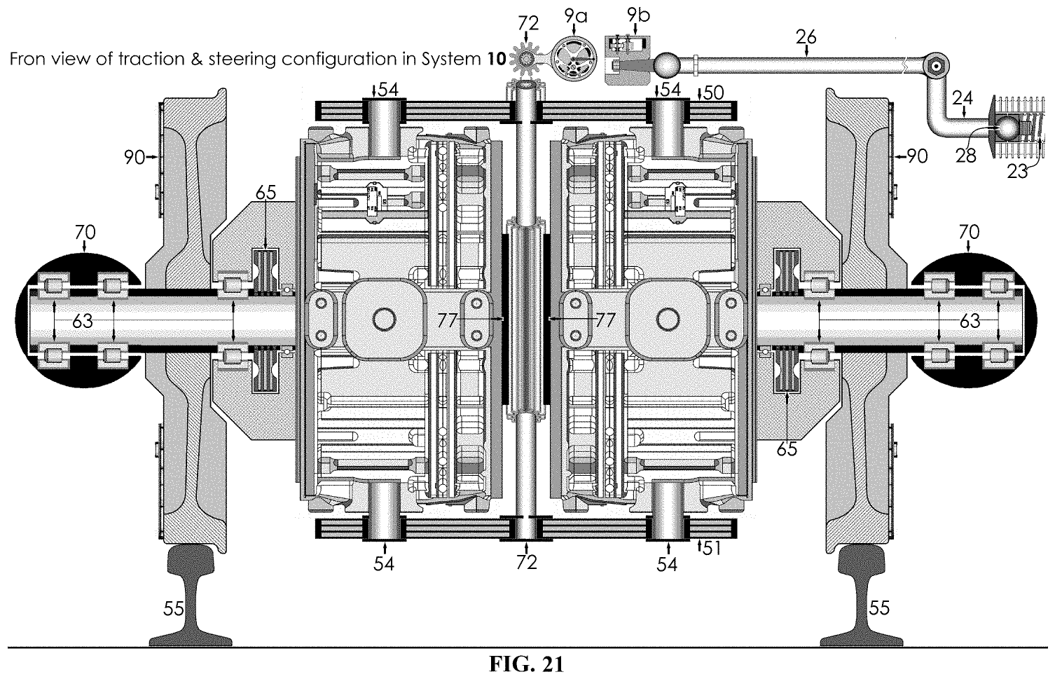

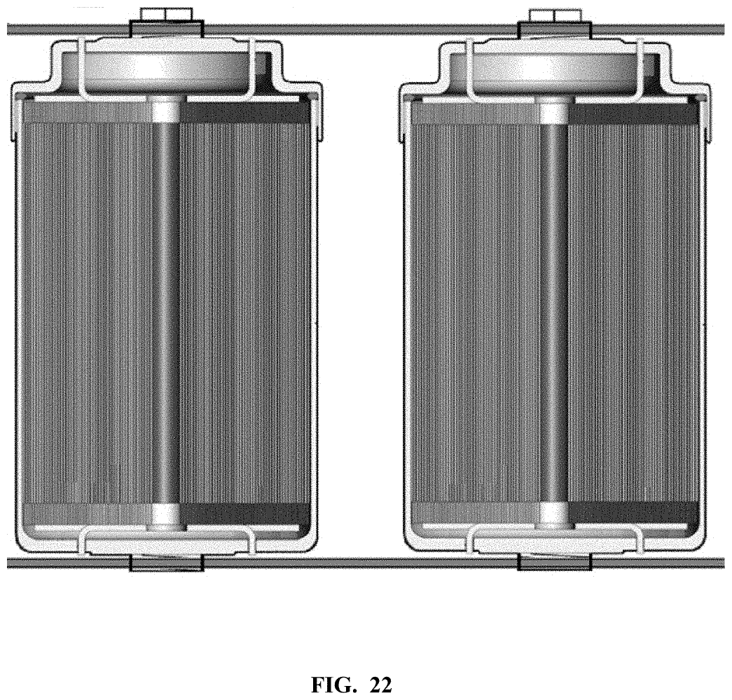

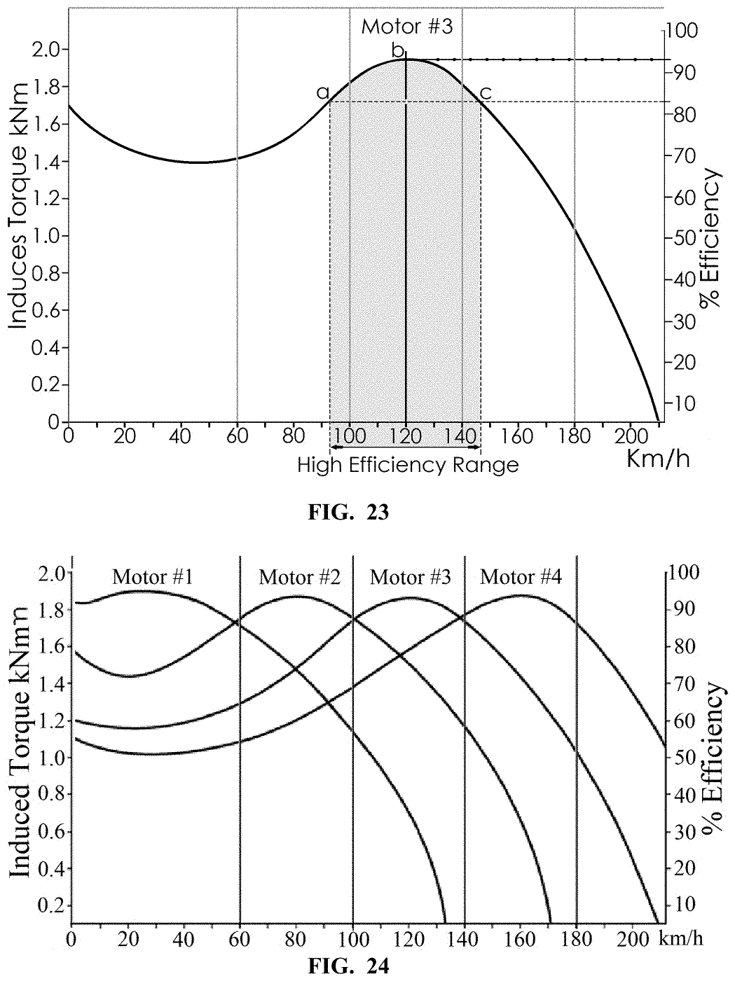

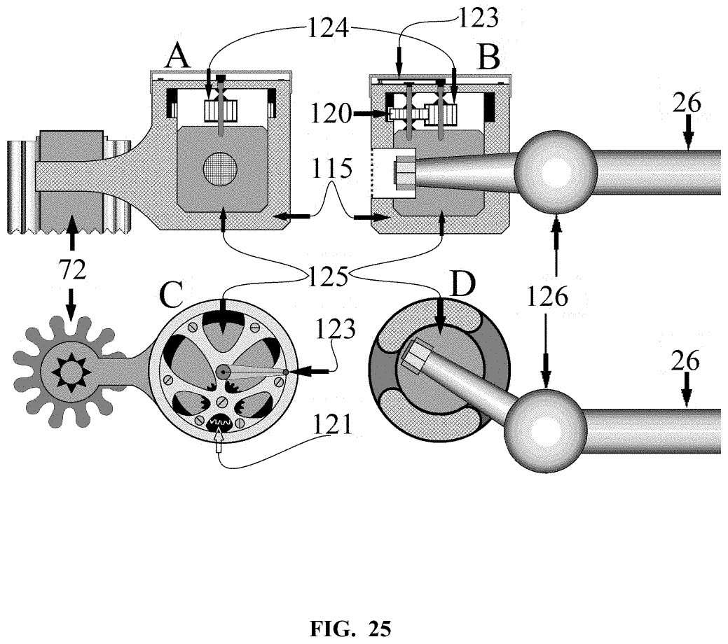

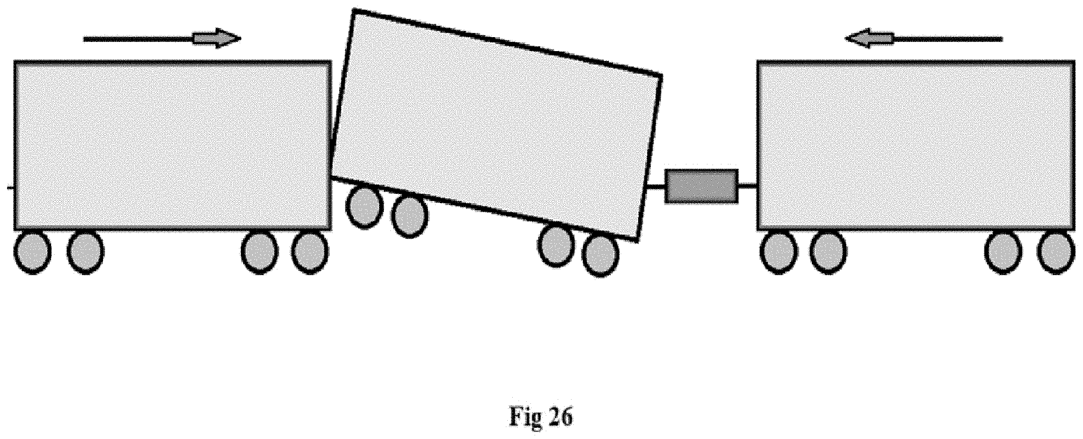

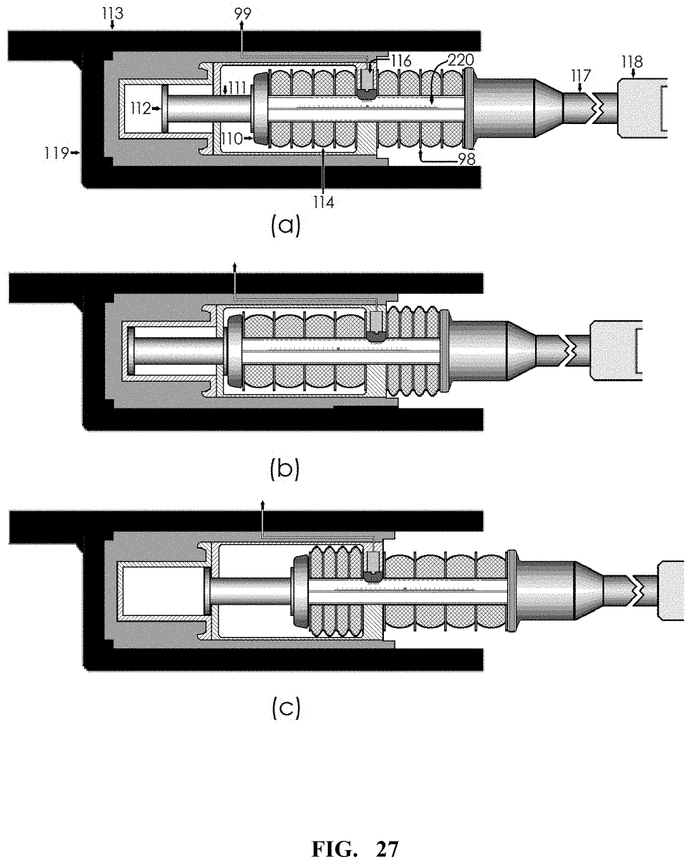

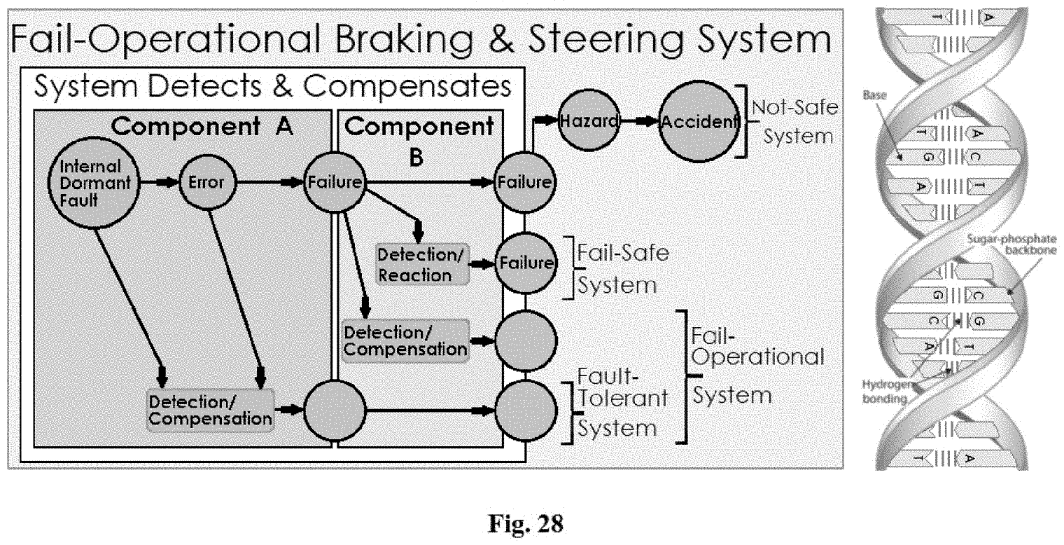

FIG. 19B is an intricate steering aggregate in a Co'Co'bogie configuration with the specific direction of rotations for each gear involved in the steering, where:
9 a yaw-sensor; ; 23 a large ball-bearing steering-screw; 23a a large nut, threaded inside and outside, wrapped around a large ball-bearing steering-screw; 24 are two steering-rods; 25 is a large steering-motor; 25a the steering-motor shaft gear that rotates a large nut, wrapped around the steering-screw gear; 25b a counterclockwise rotation of the steering-motor shaft; 26 are two tie-rods; 27 a large steering-screw ball-bearing; 28 are two steering-screw heads; 53 are steering-rod guiding studs; 67 a large cylinder in the axle-box where the center wheel-axle is rotating; 68 a bearing between the not-rotating cylinder 67 and a rotating wheel-shaft; 69a a power geared-wheel that moves cylinder 67 to the left or to the right during steering-modes; 69b a power worm-gear that rotates worm-wheel 69a; 69c a power-rod that transfers rotational movement directly from a steering-motor shaft to a worm-gear; 69d a tri-bevel-gear assembly that transfers the rotation of the steering-motor shaft to a left and a right power-rods; 70 wheel-axle steering-ball for the front and rear wheelsets; 71 are four axle-boxes for the front and the rear independently rotating wheels; 72 two long steering-columns with spur- or helical-gear for the front and the rear electric traction-motor-wheel assembly; 74 are two axle-boxes for the two center wheels' axles; 75 are twelve primary-suspensions connected to all six axle-boxes; and 90 a disc-brake fixed to the wheel.

FIG. 20 is a magnified, top and front view of a center axle-box 74 where: 50 and 51 are the bogie metal roof and floor respectively, as additional support for power-rods 69c, and a guide for the electric traction-motors during steering maneuvers; 62 a wheel-axle; 63 are large ball-bearings supporting the wheel-axle; 67 a large cylinder in the axle-box where the wheel-axle is rotating, yet the cylinder is moving up and down but is not rotating; 68 a bearing between the not-rotating cylinder 67 and a rotating wheel-axle assembly; 69a a power worm-wheel that moves cylinder 67 to either direction during steering-procedures; 69b a power worm-gear that transfers the rotational energy from the steering-motor shaft, through a bevel-gear, to worm-wheel 69a; 69c a power-rod, configured to support worm-wheel 69a. Power-rod 69c is running from the bogie roof 50, through the center of worm-wheel 69a, to the bogie floor 51; 74 a wheel-axle box for the center electric traction-motor; and 75 are two primary-suspensions connected to axle-box 74.

FIG. 21 is the instant disclosure front or rear-view of independently rotating wheels-assembly, discarding the bogie frame and the axle-boxes. Where: 9a and 9b are top and side view of the yaw-sensor, respectively; 23 a part of a large steering-screw; 24 a steering-rod; 26 a tie-rod; 28 a steering-screw heads; 50 and 51 are the bogie metal roof and floor, respectively as additional support and stability to opposing electric traction-motors; 54 are steering-studs that stabilizes and guide an electric traction-motor during steering maneuvers; 55 represents a rail-track; 63 are three large bearings on a wheel-axle; 65 are wheel-axle gears [the motor-shaft gears 64 are not in view because they are camouflaged by the wheel-shaft assembly]; 70 a wheel-axle steering-ball; 72 a spur- or helical-gear long steering-columns, getting its stability by being supported by the bogie metal roof 50 and floor 51; 77 are steering teethed-racks on the outer-wall of opposing electric traction-motors, which meshes with a long steering-column spur- or helical-gear; 72; and 90 is a wheel disc-brake, configured on all wheels with electric brake system.

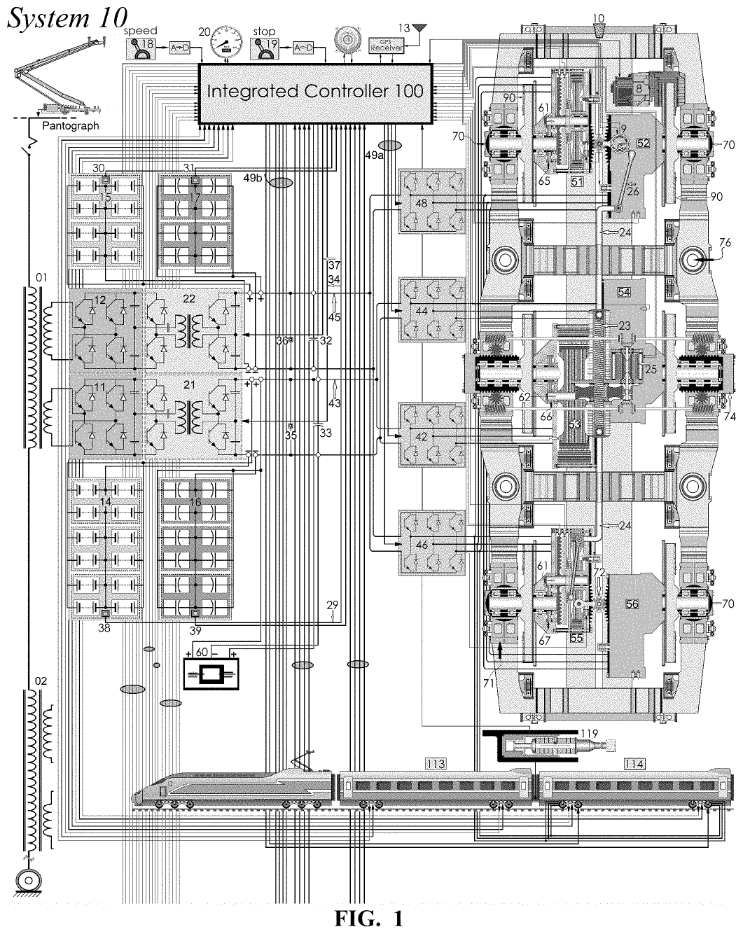

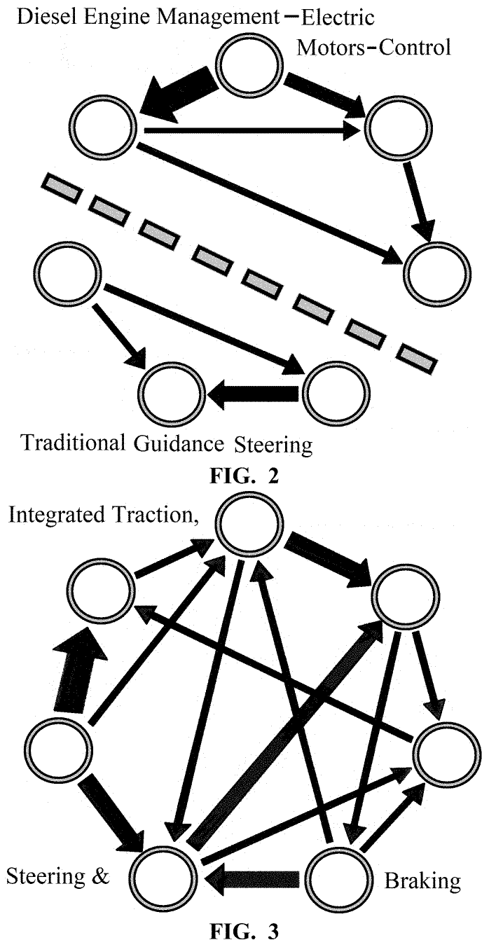

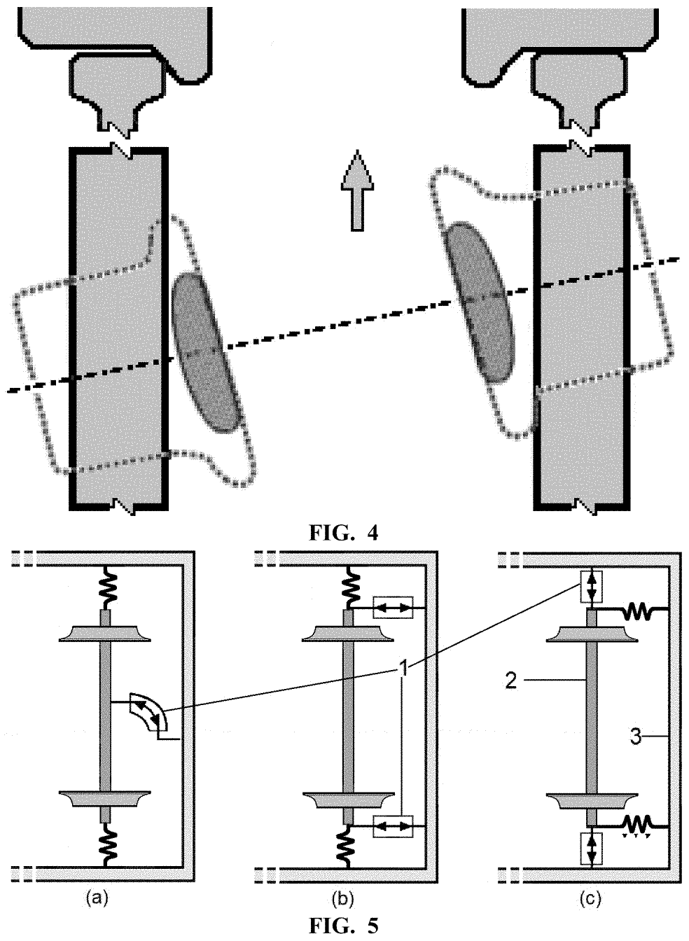

FIG. 22 represents two out of multiple, parallel connected, large ultra-capacitors as presented inside energy-storage 16 and 17 in FIG. 1.

FIG. 23 is a chart of a typical distribution of power, speed & efficiency in AC-motors. This particular chart represents Motor #3 from FIG. 24, which has the best efficiency range between 83% and 93% in the speed ranges between 97 and 144 Km/h.

FIG. 24 is a chart representing four groups of differently designed electric traction-motors, configured with different ranges of efficiency in different ranges of speed. This set-up may operate in average efficiency above 90% between 0 and 180 Km/h.

FIG. 25 is four different cross-sections of yaw-sensor 9 as configured in every bogie of the instant disclosure. It monitors the instant wheels position and transmit the data to a controller; where A is a side cross-section, B is different side cross-section, yet perpendicular to cross-section A; C is a top view of yaw-sensor 9 with the attachment to the long spur- or helical-gear steering-column 72; and D is a cross-section through the middle of yaw-sensor 9, showing the location of tie-rod 26 as it is attached to yaw-sensor cylinder 125, whereas 120 is the side-gear that move center-gear 124 that moves pointer 123 on the face of yaw-sensor 9. Before tie-rod 26 enters cylinder 125, it is configured with fixed joint 126 to afford yaw-sensor 9 free movement.

FIG. 26 “run-in” and “run-out” scenarios of articulated cars in railway-vehicles and in semi-trailers.

FIG. 27 depicts three different scenarios of the instant disclosure electronic coupler between articulated cars, whereas:
27A is the coupler's Draft Gear Unit in an ideal set-point;
27B is the coupler's Draft Gear Unit in a “run-in” scenario; and
27C is the coupler's Draft Gear Unit in a “run-out” scenario.
98 represent washers between a polymer or steel springs; 99 is an electronic connection from an IC hall-effect sensor to controller; 110 polymer or steel spring retaining front-disc; 111 a draft gear-unit-shaft; 112 a stop-disc; 113 an articulated car frame; 114 may be configured with polymer springs or a steel coiled spring; 116 an IC hall-effect sensor that monitors the changing position of a readable plate 220 inside the draft gear unit, has small projections that serves the IC hall-effect sensor to read the instant position of draft-gear shaft 111; 117 a coupler shank; 118 is a coupler knuckle; and 119 is a coupler yoke.

FIG. 28 presents a Steer-by-Wire architectural solution featuring fail-operational steering control architected with the objective of achieving steer-by-wire system safety and reliability. This architecture does not require a mechanical backup connection or a fail-operational steering column emulator design. The holistic controller detects and compensates the error by interpolating the reading of the yaw sensor in front or rear bogie and applying it to the defective bogie steering.

### DETAILED DESCRIPTION OF THE INVENTION

The embodiment of the present disclosure is described herein. It is to be understood, however, that the instant disclosure embodiment can take various and alternative forms and designs. The figures may not necessarily be to scale; some features could be exaggerated or minimized to show details of particular component[s]. Therefore, specific structural and functional details disclosed herein are not to be interpreted as limiting, but merely as variously employ the present invention. As those of ordinary skill in the art will understand, various features illustrated and described with reference to any one of the figures can be combined with features illustrated in one or more other figures to produce embodiment that are not explicitly illustrated or described. Various combinations and modifications of the features consistent with the teachings of this disclosure, however, could be desired for particular application or implementation.

Referring now to the drawings wherein like reference numerals are used to identify identical components in the various views. FIG. 1 is a block diagram view of system 10, which is one of infinite configurations possible of this disclosure: “a scalable tractive power system for electric railway-vehicles integrated into the steering and braking systems,” according to the embodiment of the invention. As will be described in detail infra, traction, steering and braking in system 10 may be configured with unmixed overhead electric receptivity; or with alternative energy sources when electric receptivity is not available, such as a mixture of battery-packs, ultra-capacitors, flywheel, and photovoltaic cells. Additional hybrid power combination may be configured with hydrogen fuel cells, and ICE utilized to actuate a generator.

System 10 comprising integrated traction, steering & braking may be configured in infinite ways in any rail-vehicle (FIG. 1). The variables may include:
the number and configuration of different energy storage-units;
the number, design, kW ratings, and torque ratings of electric traction-motors;
the electric traction-motors range of high efficiency in specific speed ranges, and
the configuration of controller 100 Multi-Objective Optimization Design (MOOD) procedures, which may be based on machine learning, generating plurality of algorithm solutions to resolve which of the locomotive's 8 or 12 electric traction-motors and which of the plurality of electric traction-motors in the articulated-cars should be coupled to wheels or de-coupled from wheels at any specific time and speed, to safely drive, steer or stop the locomotive and all articulated cars, maintaining above 90% traction efficiency and virtually 100% dynamic efficiency, whereas regenerating electric energy during deceleration.

This application discloses a philosophy and an insight that the governing module in the instant disclosure is a holistic controller (FIG. 1), configured with multi-objective optimization design (MOOD) procedures, measuring complex variable parameters and values; finding with machine learning procedures the required trade-off among design objectives to improve pertinency of solutions and to leverage synergies among plurality of differently designed electric traction-motors, electric steering motors and electric brake calipers, with which it simultaneously integrates, coordinates, and actuates the traction, steering and braking systems. The electric traction-motors may comprise in average 84 units with total average output of 10 MW or greater along a 350 meters locomotive and articulated cars. The electric traction-motors integration into the steering and braking systems reduces the traction, the steering and the braking component-size, weight, and wastage, while dramatically improves the overall efficiency of a railway-vehicle. The controller is further programmed to manage precise energy distribution, by maintaining a loop with plurality of sensors and obtaining instant information about the electric energy flow within system 10, as is particularized infra:

To avoid many months of railway-vehicles production delays—as reported in the news in this transition era of electrification—the controller design, and controller simulation must be completed before the engineering design of traction, steering, and braking mechanical components to avoid manufacturing of mechanical components the controller will not be able to control. This is parallel to nature's selection, where small brain in huge animals caused their extinction for the animal brain was unable to control basic physiological needs.

Since the locomotive engineer does not manually steers a railway-vehicle; and the fact that there are no other vehicles or ‘pedestrian’ on the rail, the future railway business is projected to be autonomous. Well, the fastest and the most efficient way to bring about autonomous mobility for railway-vehicles is to utilize this invention because, by integrating the traction, steering, and braking under full control of a holistic, digital system, while the energy of choice should be overhead electric receptivity, batteries, ultra-capacitors, fly-wheels and fuel-cells, to provide electric power from different sources, all major challenges before railway industry mentioned in [0002] supra could be easily satisfied.

Rail transportation is currently the most energy efficient (per passenger/km, or ton/km) and environmentally compatible transportation system, especially when running on overhead electric-receptivity. Whereas energy expenditure is a massive and major part of railway companies' operation costs and for this reason, it is at the focus of rail systems technology development initiatives to reduce energy consumption. Just to get an idea of energy consumption numbers: an engineer in the Swiss Federal Railway (SBB) disclosed to the above-named inventor that SBB is consuming more electric energy and diesel fuel than the greater Zurich metropolitan. Earlier, when diesel fuel was priced cents to the gallon, and electricity was produced from cheap coal, railway companies held-back improvement projects. Today's reality is that coal and diesel are unable to meet current and definitely will not meet future environmental standards, and therefore, the best and least expensive energy choice for rail-operation is electric energy from the grid.

It is to be understood, however, that the paramount objective of this disclosure is to radically reduce energy consumption by pursuing best efficiency. This application discloses embodiments that are not designed to reduce the size of the railway-vehicle with the purpose to reduce energy use-up; this disclosure is focusing on improving multiple ‘engineering oversights’ from the era of cheap energy with no pollution standards. The era of cheap fuel and no pollution regulations is gone forever; and therefore, transportation engineers should concentrate exclusively on solutions for maximum efficiency, which will produce lower pollution levels. All developments of electronic gadgets and autonomous transportation is now a priority, for now.

### Efficient Energy Resources and Energy Storage Units

Diesel was last century the fuel of choice in railway-vehicles traction. This application discloses several clean-tech, and low-cost alternatives to diesel fuel, in addition to existing overhead electric receptivity and third electric-rail.
Energy storage-units: such as battery-packs, ultra-capacitors, and flywheels may be configured as secondary energy-resources, as depict in system 10 (FIGS. 1, 11, 14, 15, 16 and 17). Energy producing-units: photovoltaic panels on-top of a 220 [12 wagons] to 325 meters [18 wagons] railway-vehicle, makes about 432 m² and 648 m², respectively of just articulated cars roof-top. Wherein average photovoltaic efficiency of 22% may produce 220 W/m², whereas the polycrystalline photovoltaic or thin-film solar cells standard efficiency rating is 37%. Then, based on a 22% efficiency rate, a 12-wagon roof-top may produce up to 95 kW and 18wagons up to 143 kW. The same set-up with 37% efficiency may produce 160 kW and 240 kW, respectively. Since railway-vehicles have 40-years amortization schedule, photovoltaics should be considered as the least expensive energy producing method.

The current fuel-cell technology is actually not serving the environment since hydrogen is produced from oil (!) Clean hydrogen production via water electrolysis has a negative energetic value in view of the fact that it takes 41.4 kWh to produce 1 Kg Hydrogen, whereas 1 Kg Hydrogen delivers only 33.33 kWh. Adding the 70% efficiency of fuel-cells, and the awfully expensive fuel-cell system, makes it obvious that today's fuel-cell technology is environmentally unjustifiable, and commercially too expensive and not practical. When the majority of electricity is produced from cheap, renewable energy, or atomic fusion reactors, fuel-cells may become environmentally, and commercially attractive.

Deriving electricity from an overhead power-line catenary or from a third power-rail is the first and most economical choice of energy supply to maintain lower pollution energy expenditure; with the exception of sections in certain areas with non-electrified lines for whatever reasons, or accidental power grid blackouts that requires alternative energy resources. Overhead powerline is so efficient that some Scania and Mercedes semi-trailers pilot projects are emulating locomotive technologies by utilizing pantographs on public highways. The second choice of energy may be plurality of storage-systems within a locomotive or on board of articulated energy-wagon. Under different circumstances, when overhead power is not available, controller 100 is programmed to move energy utilization from the power grid to any practical energy storage or energy producer on board.

### Plurality of Energy Storage Units

According to System 10 embodiment, energy storage may include one or more energy storage or energy producing system[s]. The benefits of energy storage system installed onboard of a locomotive or in a power car are as follow:
Compensation for the duration of accidental voltage drop in the power grid;
Serves as emergency power supply in areas of no overhead catenary lines;
AC traction-power created during regenerative-braking is low-voltage/high-current system. Back-flow from the DC side to high-voltage AC power grid is nonviable. The generated power has to be stored within energy-storage units on board of the railway-vehicle.
Regenerative energy greatly contributes to improved energy efficiency.

Energy storage may comprise battery-packs 14, 15 (FIG. 1) for the front bogie, and 14a, 15a, for the rear bogie [not shown]. Battery-pack 14 may feed the large electric traction-motors in the center of the front bogie and may have twelve or more positive terminals. It is directly connected to the positive terminals between bi-directional DC/DC converter 21, and AC inverters 42, 44. Battery-pack 14 may also have twelve negative terminals connected to the negative terminal between bi-directional DC/DC converter 21, and AC inverters 42, 44.

Battery-pack unit 15 may feed the medium size electric traction-motors, configured with electronic-clutches, may have eight positive terminals or more directly connected to the positive terminal between bi-directional DC/DC converter 22, and DC/AC inverters 46, 48. Batter-pack unit 15 may further have eight negative terminals directly connected to the negative terminals between bi-directional DC/DC converter 22, and DC/AC inverters 46, 48. Battery-pack units 14, 15, may also have individual integrated power management energy storage system [not shown] that may be configured as battery management logic.

According to another embodiment, DC/DC converters 21, and 22 are bi-directional buck/boost voltage converters.

In energy storage units 14, 15 within system 10, sensors 30, 38 may be installed to monitor the state-of-charge of energy storage units 14, 15, may include voltage and current sensing capabilities to measure the voltage and current of first and second energy storage units 14, 15 during operation of system 10 and transmit the data to controller 100.

Other energy storage unit embodiment may incorporate plurality of electric double layer ultra-capacitor units 16 and 17 with numerous capacitor-cells coupled to one another, where every capacitor-cell may have a capacitance between 500 and 3000 Farads or greater (FIG. 22). Ultra-Capacitor unit 16, may be directly connected to the positive terminal between bi-directional DC-DC converter 21, and DC/AC inverters 42, and 44; and Ultra-Capacitor unit 17, may be directly connected to the positive terminal between bi-directional DC-DC converter 22, and DC/AC inverters 46, and 48.

The Comparative characteristics of the ultra-capacitors and traditional batteries is given in the table infra:

| Performance | Traditional Battery | Ultra-capacitor |
|---|---|---|
| Energy | 100-200 (Wh/kg) | 10-206 |
| Number of cycles | 1000 | >500 000 |
| Specific power | <1000 (W/kg) | <10 000 |

Ultra-capacitors offer nearly instantaneous power bursts during periods of peak power demand, therefore they may be implemented as secondary energy source to complement battery-packs primary sources that suffer fast deterioration when repeatedly providing quick bursts of power; and, since traditional battery energy storage have problems supporting instantaneous high-power features—such as frequent start-stop applications, and AC grid power fluctuations—it makes ultra-capacitors the perfect answer to overcome battery limitations.

A flywheel (FIG. 1, 60) stores mechanical energy in an extra high-speed rotating wheel. It can discharge power at a higher rate compared to a battery. It has higher rates of energy storage and release compared to ultra-capacitors. Electrically driven, Magnetically Loaded Composite (MLC) flywheels are lighter and more energy efficient than conventional, mechanical flywheels. The MLC flywheels have efficiency as high as 98%. In comparison to batteries or capacitors, flywheel energy storage does not require an additional transformer and hence, the electronic circuitry is simple and smaller. The third-generation flywheels, also known as ‘Power Rings’, use radial gap magnetic bearings to store kinetic energy in order to levitate thin-walled composite hoops rotated at high speed. Power levels exceeding 3 MW and electricity storage capacities exceeding 5 MWh appeared to be technically feasible and economically attractive to provide electricity storage for railway-vehicles.

System 10 transformers 01 and 02 function is to reduce the overhead voltage to meet the onboard traction system and to isolate the on-board traction circuits from the high voltage of the overhead receptivity lines. The traditional 15 kV/16.7 Hz grid electricity or the recently more popular 25-kV/60 Hz single-phase AC is directly received and shared by four modular AC/DC converters 11, and 12 (FIG. 1, only the front bogie converters are shown). The converters may be 6.5-kV metal-oxide-semiconductor field-effect transistors (MOSFET), designed to handle significant power levels; or by insulated-gate bipolar transistors (IGBT) that combines high efficiency and fast switching properties.

System 10 is operating in either standard Charge Sustaining Mode (CSM) of operation, by drawing electricity from the grid and feeding the electric traction-motors, charging the battery-packs in energy storage units 14 and 15 and the ultra-capacitor units 16 and 17, or flywheel 60, and supplying electricity to all other consumers; or, in Charge Depleting Mode (CDM), wherein consumption of electric-energy is from battery-packs units 14 and 15, or from ultra-capacitor in units 16 and 17 or from flywheel 60 during start & stop modes or regular operation where electricity from overhead catenary lines is unavailable.

System 10 traction may include two bi-directional DC/DC power-converters 21, 22, as integral components of the six-electric traction-motors in the front bogie; and two bi-directional DC/DC power-converters [not shown], as integral components of the six-electric traction-motors in the rear bogie. Bi-directional DC/DC power-converter 21 is coupled across the positive DC link 43 to bi-directional DC/AC inverters 42 and 44, and Bi-directional DC/DC power-converter 22 is coupled across the positive DC link 45 to bi-directional DC/AC inverters 46 and 48. The negative link starts in energy storage units 14, 15, and is coupled to the negative side of each component in system 10.

System 10 may include bi-directional DC/DC converter 21 that may be connected across the positive and the negative DC link with DC bus 33 and may be connected parallel to voltage sensor 35 to monitor the instantaneous bus voltage. Bi-directional DC/DC converter 22 may be connected across the positive and the negative DC link with DC bus 32 and may be connected parallel to voltage sensor 36 to monitor the instantaneous bus voltage.

Bi-directional DC/DC converters 21, 22 [only front bogie is shown], are configured to convert one DC voltage to another DC voltage either by bucking or boosting the DC voltage. According to one embodiment, each bi-directional DC/DC converter 21, 22, [only front bogie is shown], includes an inductor coupled to a pair of electronic switches and coupled to a pair of diodes. Each switch is coupled to a respective diode, and each switch/diode pair forms a respective half phase module. Switches may be isolated gate bipolar transistors (IGBT), metal oxide semiconductor field effect transistors (MOSFET), silicon carbide (SiC) MOSFET, gallium nitrite (GaN), bipolar junction transistors (BJT), or metal oxide semiconductor-controlled thyristors (MCT).

In system 10, both energy storage units 14, 15 may be coupled via DC bus 33 and 32 to all electric traction-motors or any other combination of partial loads. Controller 100 may actuate any number of electric traction-motors in any traction mode, speed, or load conditions, utilizing multi-objective optimization algorithm to determine which of the electric traction-motor configurations would use up the minimum energy in any given traction procedure to reach the most efficient power level.

In one embodiment of system 10, each of the DC/AC inverter 42, 44, 46, and 48 includes six half-phase modules that are paired to form three phases, with each phase is coupled between the positive DC links 43, 45 of the DC bus 32, and 33 and the overall negative links of system 10. It is contemplated thus, that three-phase inverters 42, 44, 46, and 48 described herein may be designed to accommodate any number of phases in alternative embodiment.

### Scalability and Precise Tractive-Power Control

In traditional railway-vehicles, the traction system is concentrated in the locomotive and all articulated cars are dragged behind with no tractive-power or wheel-steering whatsoever. The first major step in railway-vehicles efficiency improvement emerged when plurality of electric traction-motors was installed in selected articulated cars. In the last two decades, Siemens and Bombardier manufactured their long distance Intercity Express ICE-Series, and V300 Zefiro, respectively, designed with electric traction-motors in 50 to 63% of all articulated cars, whereas discarding the traditional power-locomotive design all together.

This application discloses a second major step to improve efficiency by selecting the best electric traction-motors that will do the job the most efficient way and with the lowest weight to power ratio. The table infra lists the four most common electric traction-motors in the railway industry:

| | DC | Induction | Synchronous | |
|---|---|---|---|---|
| Motor Type | Motor | Motor | Motor | PMSM* |
| Rated Output (kW) | 230 | 1200 | 1100 | 770 |
| Mass (kg) | 825 | 1980 | 1450 | 740 |
| Mass/Power (kg/kW) | 3.59 | 1.65 | 1.32 | 0.96 |

*Permanent Magnet Synchronous Motor

ICE-4 and the V300 Zefiro railway-vehicles are configured with a single-speed solid-axle gearbox with 3-phase asynchronous induction motors. Both railway-vehicles deliver power output of about 10 MW. ICE 4 distributes the power in 6 power-cars with 24 driven-axles, with about 400 kW in each axle, while V300 Zefiro distributes the same power in 4-cars with 16 driven-axles, with about 660 kW in each axle.

This application discloses a larger number of electric traction-motors in the locomotive and in selected articulated cars, configured as modification of Independently Rotating Wheels (IRW) to improve dynamic efficiency and dramatically reduce the electric traction-motors size. Distribution of plurality of differently designed electric traction-motors would provide much better maneuverability, and the security that a railway-vehicle will never stop since power distribution among plurality of electric traction-motors will eventually eliminate mechanical break-downs because, even though one or several electric traction-motors malfunction, the rest electric traction-motors will suffice to keep the railway-vehicle running, which is a top priority, especially in the railway industry where passengers are expecting a train to be on time.

This application discloses plurality of differently designed, asynchronous, and permanent-magnet synchronous motors to operate above 90% efficiency in specific range of the railway-vehicle velocity (FIG. 24). To bring electric-motors to operate above 90% efficiency within different speed and load, a diversity of parameters may be considered to design several groups of motors in such a different way, in which every group of electric traction-motors operates in let's say from forward-motion start to 50 km/h at over 90%; the next group overlap the first one and operates from 45 to 98 km/h above 90% efficiency; the third group of electric traction-motors operates from 95 to 147 km/h above 90% efficiency; and the fourth group of electric traction-motors operates from 145 to 197 km/h above 90% efficiency to pull off a continuous traction above 90% efficiency from forward-motion start to the listed top-speed rating of the railway-vehicle (FIG. 24).

This application discloses a third, most remarkable efficiency upgrade, implementing a digital, scalable traction-control system. Railway-vehicles electric traction-motors operate in constantly changing speed and load condition, apart from factory electric motors that run at constant load and speed at all times. Therefore, it is bad notion to seek better efficiency by depending on just four or six exceptionally large electric traction-motors in a locomotive that must pull 5000-tons or more [in freight railway-vehicles] when most of the time only 24% to 76% of this power is needed to maintain traction, especially in scenarios when a freight railway-vehicle returns to base empty; or when a passenger railway-vehicle is pretty much empty, and may weigh less than 900-ton, and in frequent scenarios of start-stop.

A railway-vehicle may require 10 MW and 200-300 kN tractive-power at forward-motion start. With traditional 4, or 6 massive electric traction-motors in the locomotive that are permanently fixed to the wheel-axles, at tractive-power start the traditional electric traction-motors may utilize 75% to 85% of their rated power to pull-out the 10 MW and 200-300 kN tractive-power. However, this power is utilized for less than 60 second, wherein the load requirements drop, the efficiency of the massive electric traction-motors drops between 25% and 40%, depending on other factors. This application discloses a scalable tractive-power system that de-couples a computed number of electric traction-motors in about 60 seconds after forward-motion start, whereas maintaining 75% to 85% load distribution among the remaining coupled electric traction-motors, to keep efficiency above 90%.

The energy loss per railway-vehicle stop in terms of other parameters, such as: gravitational potential energy (second term Eq.3) in meters of altitude ˜25-m of altitude; curving-resistance (third term Eq.3) , ˜16 Km of resistance due to curvature of 400-m radius; traction-resistance (fourth term Eq.3), ˜18 Km of traction-resistance; and air resistance (Part of traction resistance) ˜38 Km of traction-resistance, depending on the railway-vehicle speed. What can be seen at a glance is the extremely high cost of stop starts compared to other parameters. High densities of tight curves can also add to considerable inefficiencies.

The minimum energy required for a trip can be estimated by assuming an average railway-vehicle speed and computing the sum-of-the-resistances to motion, including the potential energy effects of changes in altitude. The work carried out to get a railway-vehicle up to running speed once must also be added. Minimum trip energy can be estimated with the following equation:

$${E}_{min} = \frac{1}{2} {m}_{t} {v}^{2} + {m}_{t} g h + {\sum }_{i = 1}^{q} ( {m}_{i} {\sum }_{j = 1}^{r} [ {\int }_{0}^{x = {l}_{cj}} {F}_{crj} d x ] ) + {\sum }_{i = 1}^{q} ( {m}_{i} {\int }_{0}^{x = L} {F}_{prj} d x ) \qquad Eq . 3$$

Where: Eₘᵢₙ is the minimum energy consumed, in Joule; g is gravitational acceleration in m/sec²; h is the net altitude change in m; L is the track route length, m; lcj is the track length of curve j in m; mi is individual vehicle mass i in kg; mt is the total railway-vehicle mass, in kg; Fcrj is the curving resistance for curve j in Newtons; Fpri is the propulsion resistance for vehicle i in Newtons; q is the number of vehicles; and r is the number of curves.
Eq-3 is a useful equation in determining how much scope exists for improved system design and practice. It is further illustrative to consider a simple example of a 2000-ton freight railway-vehicle with a running speed of 80 km/h. The work carried out to bring the railway-vehicle to speed by kinetic energy term, is lost every time the railway-vehicle must be stopped and partly lost by any brake application.

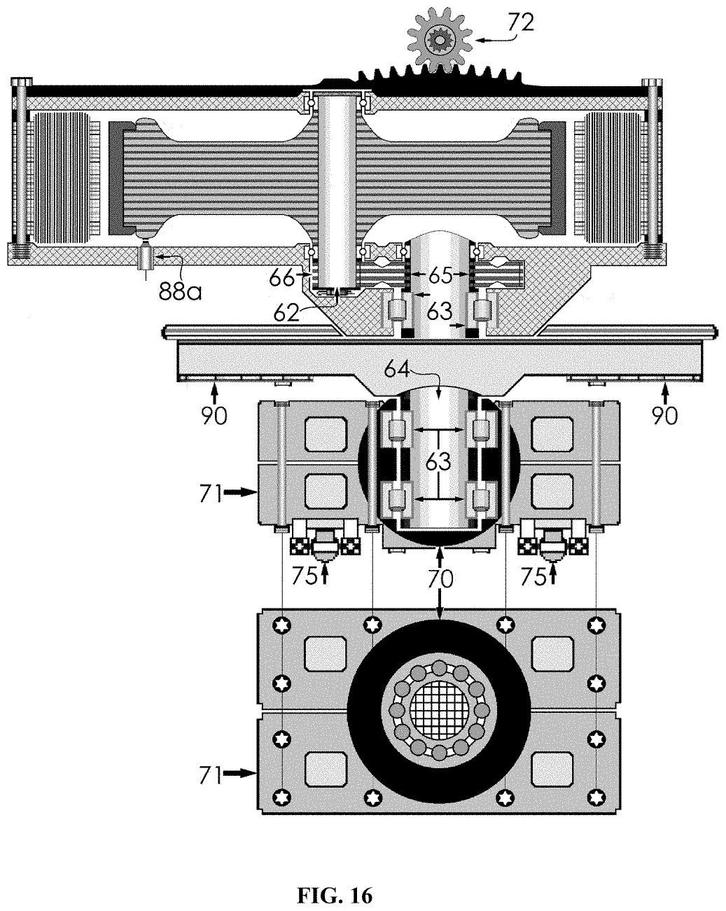

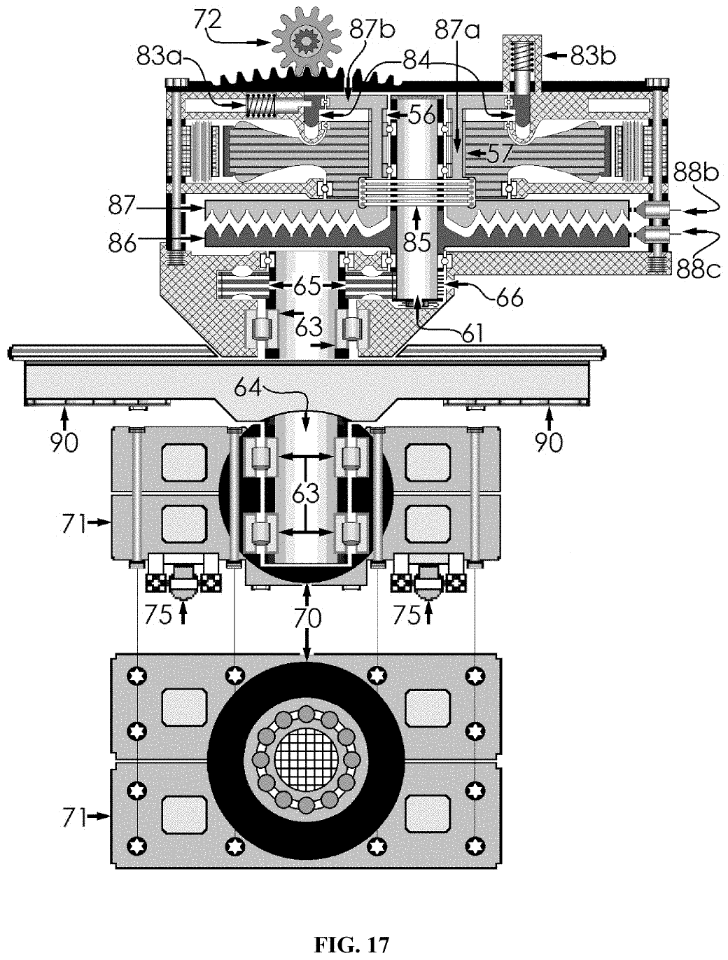

System 10 utilizes two fundamental designs of electric traction-motors: motors without clutches (FIG. 16), and motors with electronic-clutches (FIG. 17) to enable coupling and de-coupling of electric traction-motors to and from wheels, to maintain an efficient, scalable power-control.

DC Electric Traction-Motors could not Fit in System 10 for Three-Reasons:
(i) System 10 average electric traction-motor may range between 200-400 kW, whereas a 300 kW DC motor weigh about 1.2 tons, while a 300 kW PMSM weight just 288 Kg.
(ii) two 1.2 tons DC electric traction-motors could not fit between two wheels in a standard 1435 mm rail-gauge, especially electric traction-motors with electronic-clutches (FIG. 17); and
(iii) DC-motors are not as efficient as PMSM, which will reduce the overall efficiency goal the instant disclosure is seeking to accomplish.

FIG. 17 depicts a cross-section in an electric traction-motor with electronic-clutch assembly. It is obvious that the electronic-clutch section with the solenoids and the two clutch discs takes more than 50% of the electric traction-motor space. The small space left for the rotor and stator suggest that a PMSM is the best choice for electric traction-motors with electronic-clutches for their lowest weight to power ratio. Besides, the key merit of a PMSM is its high efficiency, which is the paramount goal of the disclosure; and, since electric traction-motors with clutches are coupled to the wheels in average only about 25% of tractive-time, it may assist combating the overheating demerits of PMSM.

The best choice for electric traction-motors without electronic-clutches (FIG. 16) may be high-efficiency, asynchronous induction motors for their robustness and durability, as clutch-less electric traction-motors are rotating whenever the railway-vehicle is in motion. Those motors should be carefully designed to avoid deterioration of copper and other metals in the rotor and the stator, to improve the overall efficiency, and save energy. Both traction-motors, asynchronous and PMSM should be totally enclosed (FIG. 21) for better efficiency and better cooling considerations. There are numerous, small improvement-steps to achieve better efficiency in electric traction-motor, and they all should be considered before designing the appropriate motor because ‘life expectancy’ of an electric railway-vehicles is 40-years. Yet, detailed efficiencies are multifaceted and depend on numerous factors which is not in the scope of this disclosure.

System 10 electric traction-motors without clutches (FIG. 16) represents the basic tractive-effort required to move an empty railway-vehicle on a flat rail. Assuming this power to be about 24% of the maximum traction-power then, taking 10 MW as the average top tractive-power utilized by leading railway-vehicle manufacturers, 2400 kW power level could be achieved with six-400 kW or eight-300 kW electric traction-motors, while the rest 76%, or 7600 kW, power-level, which is an adjustable power that controller 100 may divide among thirty-eight (38)-200 kW or twenty-six (26) 300 kW electric traction-motors, is installed in the locomotive and in selected articulated cars. Three quarters of the traction-power is the flexible 7.6 MW is utilized only when controller 100 elects to couple a fraction or all 38 or 26 electric traction-motors into the propulsion process, or de-couple a fraction or all 38 or 26 electric traction-motors when less tractive-power is needed. This scalable power-control should save in average 40% electric energy in addition to the 10-15% saved with traditional vector control. 40% of the multi-mega Watts each railway company utilizes every day—especially in Europe where kWh price is double and triple the price in the US—should not only save billions of dollars but also spare the atmosphere of multi-million tons of CO₂.

Each pair of electric traction-motors may comprise similar configuration to keep power balance between the left and the right side of the locomotive, and articulated power-cars. Yet, each electric traction-motor may be provided with different torque, and different speed to maintain the best calculated dynamic efficiency while negotiating a curve. System 10 (FIG. 1) comprises electric traction-motors 51, 52, 53, 54, 55 and 56 [rear bogie not shown] whereas electric traction-motors 51, 52 and 55, 56 are configured with electronic-clutches while electric traction-motors 53, 54 are configured without clutches. In theory, opposing electric traction-motors in the same axle have the same design but they may not connect to the same DC/AC inverter because during steering procedures, the electric traction-motor opposing the turning-center is actuated with higher speed and more powerful torque than the electric traction-motor facing the turning center. Therefore, electric traction-motors 51, 55 receive their electric current and modulation from DC/AC inverter 46; whereas electric traction-motors 52, 56 receive their electric current and modulation from DC/AC inverter 48. The large electric traction-motors 53, 54 in the center of the bogie have their individual DC/AC inverters 42, 44 respectively, because being installed at the left and the right side of the locomotive, electric traction-motors 53, 54, may be actuated with different speed and torque, especially during steering, and braking processes.

Electric traction-motors in system 10 may include geared power-transmissions 65, 66 and 67 (FIG. 1, shown only for three traction-motors in the front bogie), coupled to corresponding electric traction-motor shafts 61, 62 and 63. Geared power-transmissions 65, 66 and 67 [not shown in detail], may be constructed as single or multi-gear-drive; toothed-belt driven; chain driven or a combinations thereof, with innumerable design embodiment. According to other embodiment, four geared power-transmissions 65, 66 and 67 [not shown in detail], may be configured as electronic-variable transmission (EVT) that couples the output-shafts 61, 62 and 63 of electric traction-motors 51, 52, 53, 54, 55 and 56 to an internal planetary gear [not shown].

### Electronic Electronic-Clutch with a Six-Solenoids Scheme

It is imperative to elucidate the precise structure of electric traction-motors with electronic-clutches (FIG. 17) before proceeding with the intricate steps of coupling and de-coupling procedures. In traditional automobiles a double-sided disc-clutch is sliding on splined-shaft between the gearbox and the engine's flywheel. The clutch-disc meshes unto the flywheel and is rotating whenever the engine is rotating. The clutch-disc shaft ends inside a gearbox with a gear that is rotating freely once the engine idles in a stop position. When the driver presses the clutch-pedal, the clutch-disc is de-coupled from the flywheel, while the clutch-gear shaft speed is reduced. At this point the driver may move the gearshift to any gear and releases the clutch pedal, which couples the engine crankshaft with the wheels.

FIG. 17 displays system 10's (FIG. 1, electric traction-motors 51, 52, 55 and 56) intricate, yet seamless electric-clutch operation. Rotor shaft 61 is not securely fixed to the rotor of the electric traction-motor. Rotor shaft 61 is partly molded with splines to allow clutch-cylinder 87a to move back and forth on the splines molded inside 57 and outside 56 clutch-cylinder 87a, to facilitate movement of the electric traction-motor disc-clutch assembly 87 forward while coupling, and backwards while de-coupling the electric traction-motor to and from the wheel, respectively.

Coupling the electric traction-motor: when the wheel is in motion, wheel-axle 64, wheel-axle gear 65, rotor-shaft gear 66, discs-clutch 86 and rotor-shaft 61 (FIG. 17) are all rotating whenever the railway-vehicle is in motion, yet the electric traction-motor is stationary because disc-clutch 87 is not coupled to disc-clutch 86. However, wheel-axle 64 rotates much slower than rotor-shaft 61, depending on the gear-ratio between rotor-shaft gear 61 and wheel-shaft gear 64.
In coupled mode: disc-clutch assembly 87, 87a and 87b is couples to disc-clutch 86. This scenario takes place twice:
(i) before forward-motion start all electric traction-motors are coupled to provide tractive-effort of about 200-300 kN; and
(ii) during tractive operation when controller 100 actuate specific electric traction-motor and couples it to the wheel.

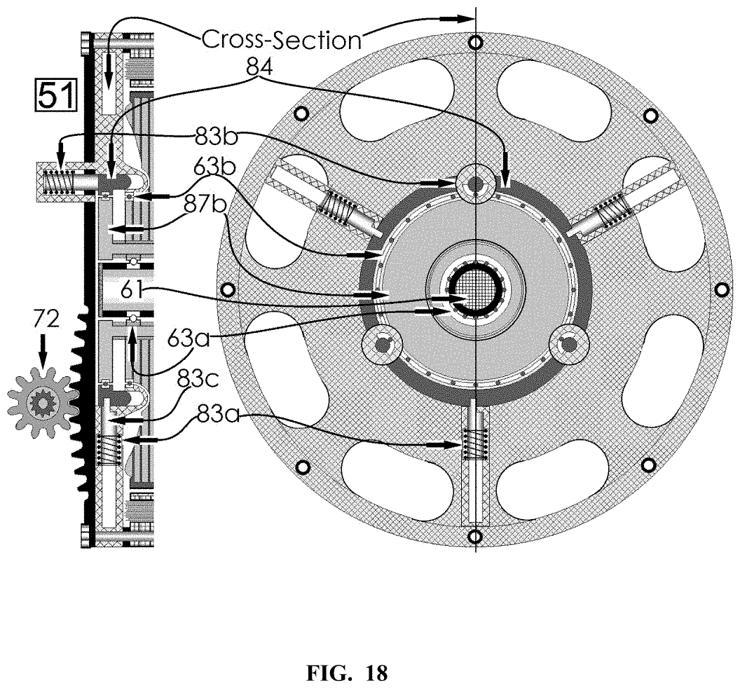

The operative concept of coupling & de-coupling electric traction-motors to and from wheels is based on Einstein theory of relativity and is illustrated in FIGS. 17 and 18. Einstein theory of relativity pertaining space and time, published 1915 with the title: “Zur Elektro-dynamik bewegter Körper” (“On the electro-dynamics of moving bodies”), verified that there is no fixed frame of reference in the universe, and every moving body relates to every other body in space and time. Yet, when two bodies travel next to each other, at exactly the same speed, relative to each other, the two bodies are stationary.

System 10 comprises two electronic disc-clutches that participate in a coupling-de-coupling mechanism. Disc-clutch 86 is propelled by the wheel; and the electric traction-motor is propelling disc-clutch 87. While the two discs are firmly coupled, two different operations may take place:
(i) when the electric traction-motor is actuated, the power from the electric traction-motor is transferred to a corresponding wheel; and
(ii) when a railway-vehicle is decelerating, the railway-vehicle kinetic energy is transfer to the electric traction-motors through the wheels, while an electric traction-motors operate as generators, and the railway-vehicle goes into a regenerative procedure.

Controller 100 is inter alfa, programmed to maintain the most efficient tractive force by selecting all or less than all 38 or 26 electric traction-motors with electronic-clutches, which are considered as the scalable instrument in system 10, to maintain a variable, precisely computed energy use-up. Controller 100 may undertake the following procedures to execute the intricate coupling and de-coupling procedures in all 38 or 26-motors in system 10:

Coupling the electric traction-motor to wheel, involves several steps:
(i) Before coupling, the electric traction-motor is stationary, and so is disc 87, yet disc 86 is rotating whenever the railway-vehicle is in motion. However, when one disc is stationary and the other disc is rotating, no coupling can occur because both discs surfaces are configured with concave indentations and convex projections that fits perfectly one into the other when the two discs are firmly coupled. It is obvious that to implement Einstein theory of relativity, disc 87 revolutions must precisely match the revolutions of disc 86.
(ii) The revolutions of disc 86 is continuously monitored by speed sensor 88c and the data is transmitted to controller 100. At the same time, the revolutions of disc 87 [when rotating] is monitored by speed sensor 88b and the data is transmitted to controller 100. Because the electric traction-motor before coupling is stationary and not under load, controller 100 may actuate and spin the electric traction-motor in a fraction of a second to precisely match the revolutions of disc 87 to the revolutions of disc 86 via loop with sensors 88b and 88c.
(iii) When discs 86 and 87 are rotating at exactly the same speed, controller 100 may then actuate with electromagnetic means three-solenoid-set 83a (FIGS. 17, 18), to pull-back locking-latches 83c (FIG. 18) configured in all three solenoids 83a at the same time, which triggers the release of the electronic-clutch circular-gear 84.
(iv) A powerful spring 85 (FIG. 17)—is installed around disc cylinder 87a behind disc 87, while is pressed into the rotor—thrusts the already rotating motor-side disc 87 forward, to couple with disc 86 while both discs are rotating at precisely the same angular speed. Both discs are configured with indentation and projections to perfectly mesh tight one into the other. At this point of coupling, rotational energy is transferred from the electric traction-motor to the wheel via rotor-shaft 61, to rotor-shaft gear 66 to wheel-axle gear 65, and to wheel-axle 64 that propels the wheel.
(v) Once discs 86 and 87 are tightly coupled, controller 100 deliver to electric traction-motor 55 (FIG. 1)—through DC/AC voltage inverters 46—the appropriate voltage, current and frequency modulation to satisfy the computed torque and speed required for optimal tractive-power in every method of operation within the integrated traction, steering and braking in the locomotive and in articulated cars.

De-coupling the Electric traction-motor from wheel, involves two steps:
(i) To disconnect the electric traction-motor from the wheel, controller 100 may actuates the powerful three-solenoid-set 83b (FIGS. 17, 18), by means of electromagnetic force to pull-back disc 87 assembly, which includes electronic-clutch circular-gear 84, disc-tail 87b, disc-cylinder 87a and disc-clutch 87. Solenoid-set 83b may be configure more powerful than solenoid-set 83a because solenoid 83b must overcome the elastic energy of spring 85 while compressing the spring; and
(ii) electronic-clutch circular gear 84 is then locked-back with the three solenoids latch-sets 83c (FIG. 18) in a de-coupled, stationary position.

### Integrated All-Wheel Steering for Locomotives & Articulated Cars

Railway-vehicles steering discern fundamentally from road vehicles. The first objective is that the steering procedure is autonomous and is pulled-off without a driver's assistance or interference. The second paramount difference is for having a 350-meter-long railway-vehicle with plurality of axles that have to be steered one at a time when each axle reaches the beginning of a curve; and the third objective is the fact that railway-vehicles are on track, with no ‘road options’ to steer to the left or to the right. Therefore, this disclosure steering system is autonomous, and more complicated than one with a driver's assistance, which requires attention to the collected topographic information pertaining the divergences of the track ahead of the locomotive; and in controller 100, a pre-programmed information of the distance from the front axle of the locomotive to the last axle in the last articulated car. Controller 100 utilizes Multi-objective Optimization Design (MOOD) procedures to compute a steering initiation time for each wheelset; the variable steering-angle during the time each wheel passes through the GPS provided comprehensive rail-divergence, and the time each wheel returns to straight forward position.

The above-named inventor applied the same ‘all-wheel steering’ concept in application Ser. No. 16/399,194 where 12 to 18-wheeler semi-trailer is configured with electric traction-motors and steering gears in every wheel along the tractor and the trailer. This precision cannot be accomplished merely by applying different torque and different speed to electric traction-motors in semi-trailer tractors or in locomotives. Traction and steering along railway-vehicle matches nature ‘technology’ where a caterpillar-worm has legs in every segment of his body to perfect his mobility. Keeping-in-mind that the paramount goal of this disclosure is efficiency, efficiency, and efficiency, then dragging in a curved-track 96 and more not-steered wheels of 12 articulated cars, can consume double the energy of all other inefficiency-factors combine.

Traditional ‘guidance steering’ is a strategy that keeps the wheelset closely aligned with the track in such manner that curving is implicit, and usually involves some form of feedback. Yet, this disclosure with its ‘instantly monitored and forced steering technology’ is a sophisticated concept in which knowledge of the curves and all their transitions is acquired and utilized—prior to the entry of the locomotive into the curve—either from a track database (GPS sensor information, FIG. 1, 13) or from a “look ahead” electro-magnetic (radar) sensing system (FIG. 1, 10) or the combination of both. In other words, in this disclosure, the holistic controller 100 takes over an 18-wheeler semi-trailer driver's job by steering without a glitch, not a semi-trailer on the free-way, but a 350-meter-long railway-vehicle on a rail track; and with geometric precision. It is obvious that controller 100 may slows-down before entering the curve.

The steering sequence starts when electromagnetic sensor[s] 10 (FIG. 1) in the front of the locomotive utilizes an array of inductive metal detectors to identify the divergence of the track from straight in relation to the locomotive situation. This digital data in conjunction with data gathered from the GPS-sensor (FIG. 1, 13) enables controller 100 to compute the beginning point of the divergence from straight; the exact geometry of the comprehensive curve; and the point of exit. The steering act propagates as a wave from the first locomotive axle to the last axle in the last articulated car, depending on the instant speed of the railway-vehicle. To perfect the steering of all wheels, computations are utilized to force-steer each wheelset when it hits the entry into the curve.

While each wheel in the locomotive and articulated car may carry several metric-tons of weight—to ease the steering process—controller 100 is programmed to increase the torque and speed of the electric traction-motor[s] on the opposite-side of the turning center to assist steering-motor 25 (FIGS. 1, 12b, 13b, 15b and 21) while changing the bogie's electric traction-motor-wheel-assembly angle position.

First act of steering starts when controller 100 applies different torque and different speed to opposing electric traction-motors when their axle hits the beginning of the curve, which is directly proportional to the intuited divergence of the forthcoming curved rail, and to the speed of the locomotive. This initial, traditional segment of steering is comparable with leading technologies, and is merely used for a fraction of a second to give steering-motor 25 (FIGS. 1, 11b, 12b, 13b, 14b, 15b and 21) the initial ‘push’ to change the angle of the wheels.

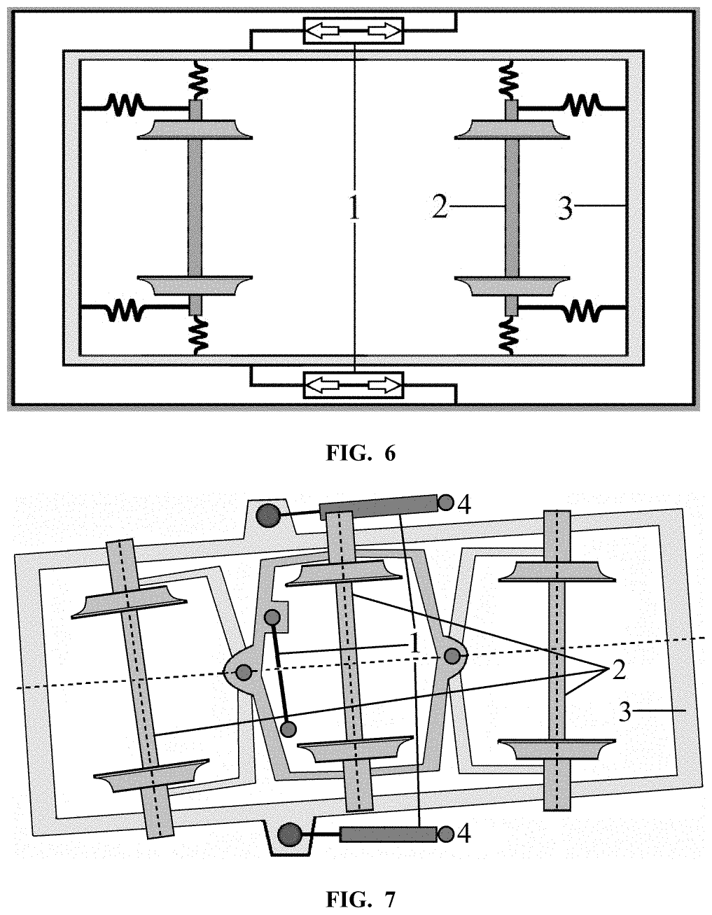

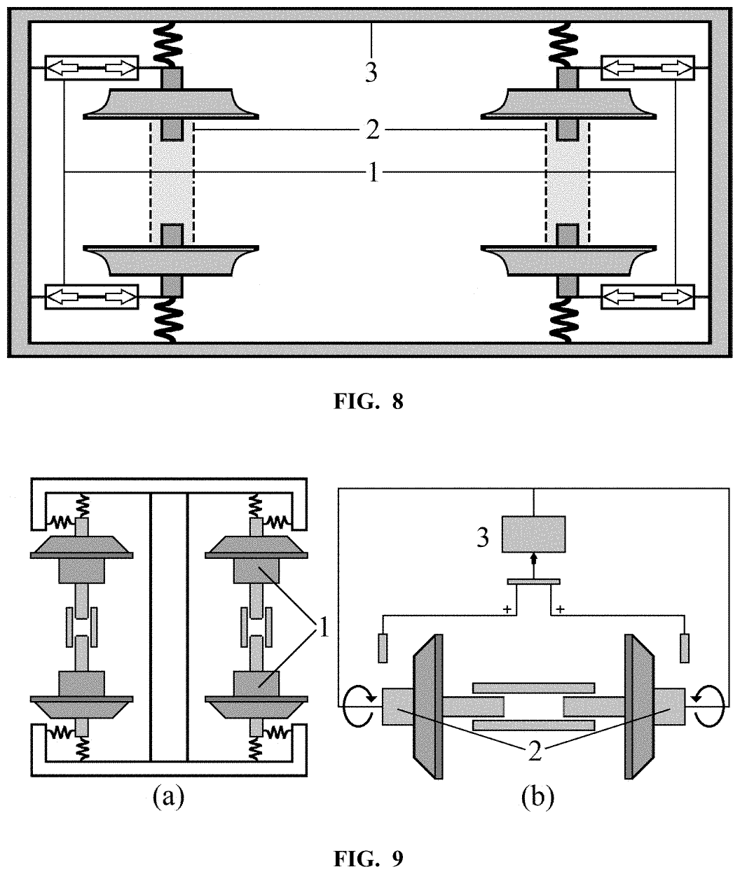

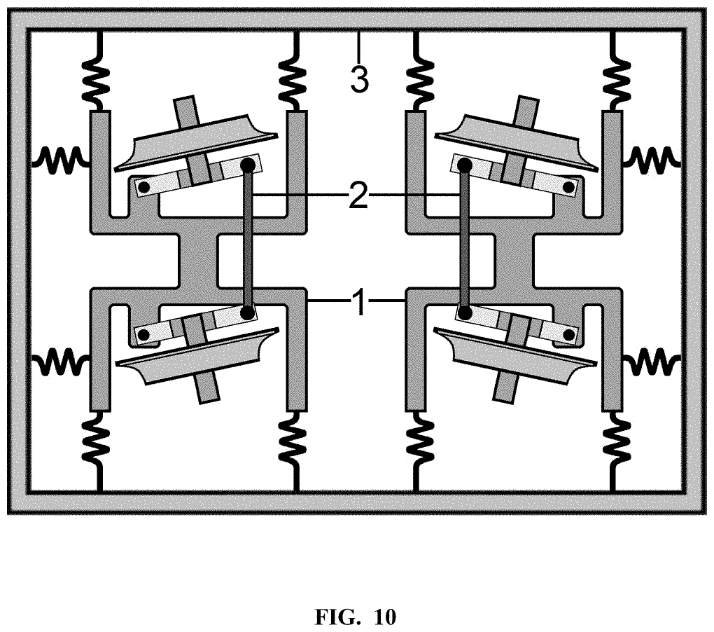

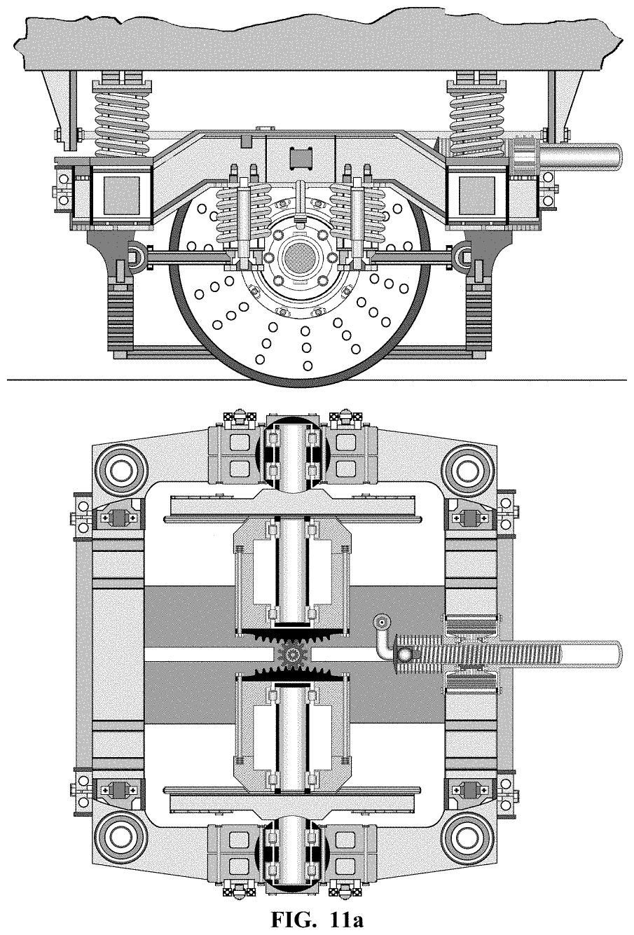

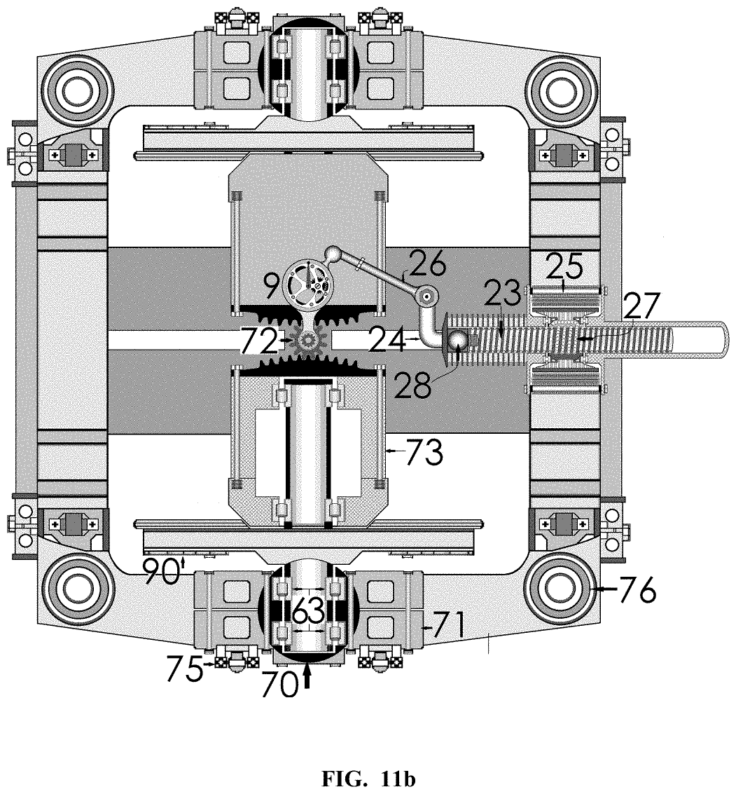

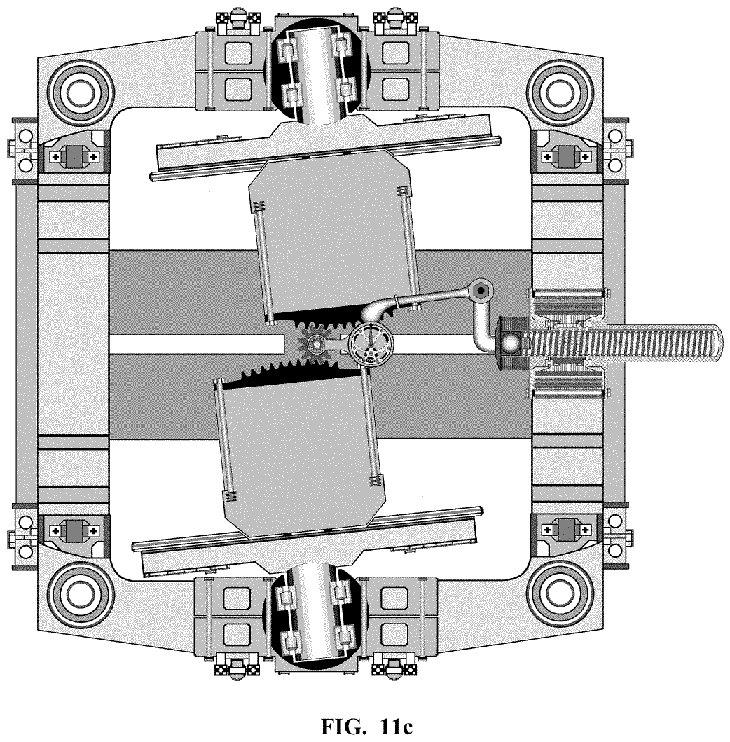

There are significant differences between this disclosure and the currently available steering systems:
(i) the leading technologies apply a passive ‘guidance strategy’ to steer the wheels only in the locomotive bogies by plainly actuating one side of solid axle wheelset to cause partial steering; or actuating opposing wheels with different torque and speed, or both to proximate the desired steering-angle.
(ii) the majority of railway companies are utilizing traditional and current steering technologies, as reviewed infra:
   Actuated Solid-axle Wheelset (ASW) FIG. 5,
   Secondary Yaw Control (SYC) FIG. 6,
   Actuated Yaw Force Steered bogie (AY-FS) FIG. 7,
   Actuated Independently Rotating Wheelset (AIRW) FIG. 8, and
   Driven Independently Rotating Wheels (DIRW) FIG. 10.
All of which are great improvement over the traditional solid axle with no steering whatsoever. Yet, even the independent rotating wheels (IRW) configurations, being the best steering performance so far, lacks the precision of this disclosure's steering-motor-yaw-sensor-controller loop, to perform a perfect geometric steering; and
(iii) This application discloses a steering technology that will dramatically minimize the metal-wheel/metal-rail friction effect caused by dragging plurality of not-steered wheels through rail-divergences. Steering all the wheels along the railway-vehicle with multiple, yet different configurations (see FIGS. 11b, 12b, 13b, 14b and 15b) will virtually diminish the dragging effect.

The key components in this disclosure's forced-steering system comprise:
(i) A single steering-motor 25 in each bogie (FIGS. 1, 11b, 12b, 13b, 14b and 15b.
(ii) A large ball-bearing screw 23 (FIGS. 1, 11b, 12b, 13b, 14b, 15b and 21).
(iii) A Steering-rods 24 (FIGS. 1, 11b, 12b, 13b, 14b, 15b and 21).
(iv) A steering tie-rods 26 (FIGS. 1, 11b, 12b, 13b, 14b, 15b and 21).
(v) A single yaw-sensor 9 (FIGS. 1, 11b, 12b, 13b, 14b, 15b and 21);
(vi) A spur- or helical-gear column 72 between two electric traction-motors (FIG. 21);
(vii) A large steering-ball 70 inside a wheel axle-box 71 (FIGS. 1, 11b, 12b, 13b, 14b, 15b and 21);
(viii) A large cylinder 67 inside a long wheel axle-box 74 (FIGS. 1, 15c, 19b & 20), in a 3-axle bogie; and
(ix) A plurality of differently designed gears with power-rods.
All nine components listed above are installed in every bogie along the railway-vehicle in two distinct configurations; a number of bogies are configured with electric traction-motors integrated in the steering system (FIGS. 1, 12b, 13b, 15b and 21); while the rest of the bogies are configured only with forced-steering systems (FIGS. 11b, 12b and 14b).

The distinctiveness of the forced-steering system in the instant disclosure is the continuous actuation and instantaneous monitoring of each wheel along the railway-vehicle, from the locomotive front bogie to the last wheelset in the last articulated car, to secure an accurate wheels-angle-position in a locomotive with two 3-axle bogies, and 1-axle or two 2-axle bogies in each of the 12 or 18 articulated cars, which may add-up to 108 and 156 steered wheels. Every sub-steering unit is confined to a bogie or to a single wheelset. Each bogie is configured with only one steering-motor 25 that actuate 2, 4 or 6-wheels, and each bogie is configured with one yaw-sensor 9, instantly monitoring the positions of 2, 4 or 6-wheels (FIGS. 1, 11b, 12b, 13b, 14b, 15 and 21), while transmitting the data to controller 100. However, the distinctiveness of this disclosure is that in a railway-vehicle with 12 articulated cars, controller 100 is in a loop with only 26 yaw-sensors 9, and with only 26 steering-motors 25, while steering 108 wheels in a geometric precision.

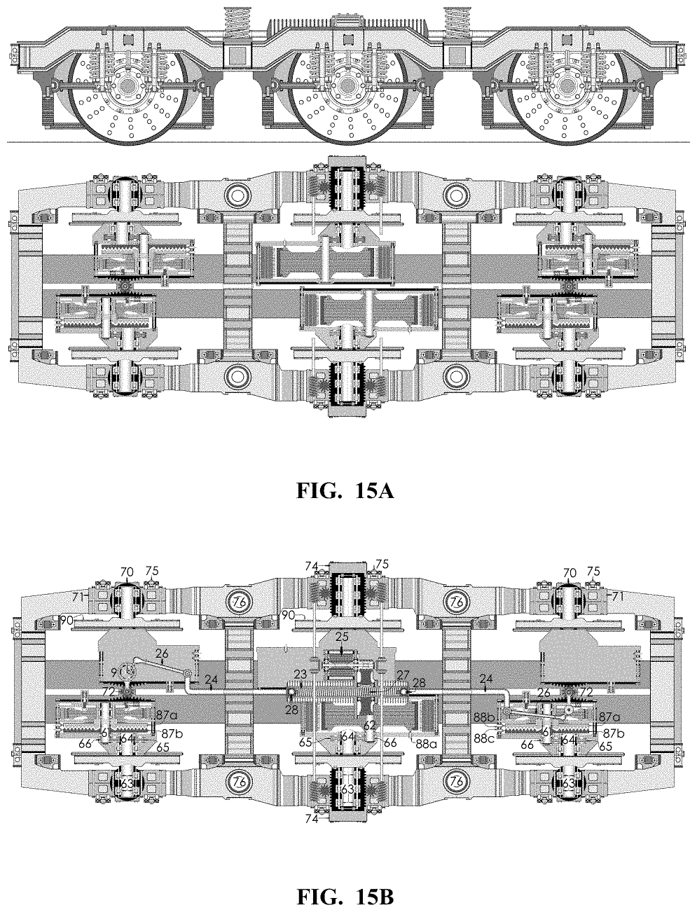

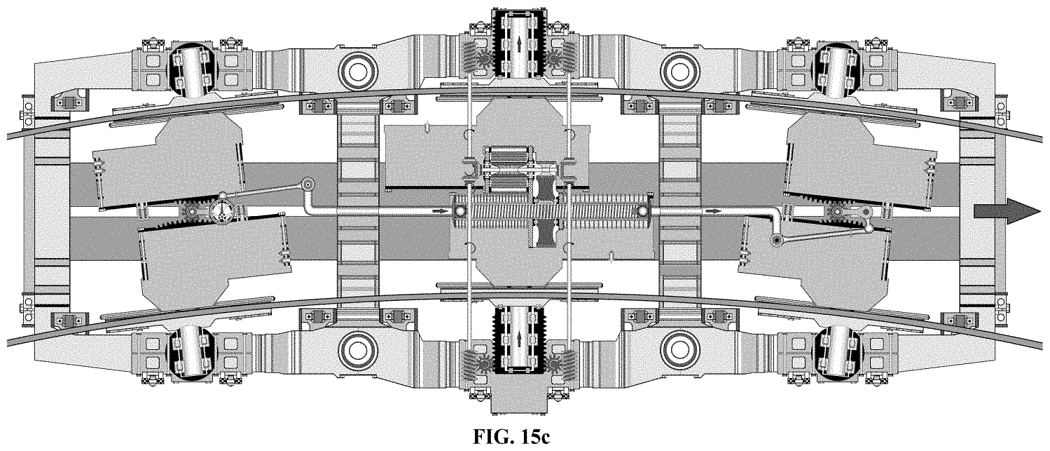

The locomotive in system 10 is configured with two three-axle bogie. The two wheels in the center of the bogie are not steered but force-moved to the opposite side of the turning center with computed precision, which creates a continuous, perfect curved-line with the wheels in the front and the wheels in the rear of the bogie (FIGS. 15c, 19b, 20 and 21). At the center-stage is a large steering-motor, wherein a single steering-motor shaft, with plurality of gears, is positioning 6-different-wheels in all different angles yet, in perfect geometric arrangement to make the curve with virtually 100% dynamic efficiency.

Spur- or helical-geared column 72 in a single axle (FIG. 11b), is meshed between two teethed-racks in the back of steering bodies 73 [without electric traction-motors]; and two Spur- or helical-geared column 72 in two and three axle bogies are meshed between two teethed-racks 77, located on the inner-side of opposing electric traction-motors (FIG. 21).

When controller 100 is actuating steering-motor 25 in a Bo'Bo'bogie configurations (FIG. 19a), a series of reactions follows:
(i) Steering-motor 25 rotor clockwise or counterclockwise rotation triggers a large ball-bearing steering-screw 23 rotation, which moves steering-screw 23, to the left or to the right in a smooth movement thank to steering-screw ball-bearing 27.
(ii) A steering-screw head 28 is configured at both ends of steering-screw 23 and attached to two a steering-rods 24, which are not affected by the rotation of steering-screw head 28, yet both steering-rods 24 are pushed or pulled to the left or to the right in the direction where the steering-screw 23 is moving.
(iii) Steering-rod 24 has a common joint with steering-screw head 28. When steering-rod 24 is actuated, it pushes or pulls tie-rod 26 through a flexible linkage 126. The other end of tie-rod 26 is bent perpendicular to tie-rod 26 before it is inserted inside yaw-sensor cylinder 125 (FIG. 25).
(iv) Pulling and pushing tie-rod 26 causes two important steps in the steering process, first it initiates the forced-steering act, and second, a yaw-sensor 9, in a loop with controller 100, monitors the instant angle change of the bogie's wheels:
(1) When yaw-sensor 9 is pulled to the right or pushed to the left (FIG. 19a), it triggers an angular change in geared column 72 since yaw-sensor 9 is fixed to the top of geared column 72. When geared column 72 is actuated, both motor-gear-wheel-assembly—e.g., electric traction-motors 51, 52 with corresponding wheels and steering-ball 70 inside axle-boxes 71 (FIG. 1)—are moved in opposite direction to each other until both wheels reach 90° to the geometric-center of the curve (FIGS. 11b, 12b, 13b, 14b, 15, 19a, 19b and 21).
(2) Whenever tie-rod 26 is pulled or pushed, it causes an incremental move of cylinder 125 inside yaw-sensor housing 115 through fixed-joint 126 (FIG. 25). The fractional rotation of cylinder 125 (FIG. 25) triggers a change in angular position of gears 120, and 124 inside yaw-sensor 9, which is proportional to the angle change of the bogie's wheels. Pointer 123 is fixed to the top of yaw-sensor gear 124 shaft. Every move of gear 124, causes the sliding of pointer 123 on a variable resistance attached to the face of yaw-sensor 9, which transmits to controller 100 the changing resistance, interpolated by controller 100 as the instant wheels position in the corresponding bogie.
If vibrations within the bogie may prevent the use of a yaw-sensor with electrical-contact such as sliding pointer 123, then, yaw-sensor 9 may be configured with non-contact IC hall-effect sensor or any configuration to record the instant angular movement of geared-column 72.

The above description of Bo'Bo'bogie configurations apply to steering of the front and rear axles in a Co'Co'bogie configuration. Whereas steering motor 25 actuate the front and the rear axles, yet concomitant, the two outer-ends of the same steering-motor 25 shaft are configured with bevel-gears, which in an intricate processes, the two wheels in the center of the bogie are not actually steered (FIG. 1) but shift to the left or to the right:
(i) Each bevel-gear on either end of steering-motor 25 shaft, is meshed in 90° with another two bevel-gears, creating a ‘C’ shape tri-bevel-gear-assembly 69d (FIGS. 1, 15b, 19b), transferring the rotation of steering-motor 25 shaft to the left and to the right bevel-gears, which are coupled to each power-rods 69c (FIG. 19b), and are rotating power-rods 69c in opposite direction, which secures a ‘same-direction’ shifting of both cylinders 67.
(ii) Four power-rods 69c are configured with a bevel-gear in one end and a worm gear 69b at the other end. Two power-rods 69c are shifting one wheel and the other two power-rods 69c are shifting the opposing wheel at the same direction (FIG. 19b).
(iii) Steering-ball 70 inside the front and rear axle-boxes 71 is modified in the center wheels into a larger cylinder 67, wrapped around the outer-end of wheel-axle 62 (FIG. 20), configured with plurality of large ball bearings 63 and is configured with a teethed-rack on both sides of cylinder 67. A worm-wheel 69a (FIG. 20) is meshed between worm-gear 69b, and the teethed-rack molded on cylinder 67 sides. Worm-wheel 69a position between worm-gear 69b and the teethed-rack on both sides of cylinder 67 is secured with power-rod 69e that runs through the center of worm-wheel 69a, perpendicular to power-rods 69c, whereas both ends of power-rod 69e is embedded into bearings fixed into bogie-roof 50 and bogie-floor 51 (FIG. 19b).

Since one steering-motor 25 actuates simultaneously two different steering processes, and with just one long shaft; wherein each steering-motor 25-shaft end brings about the rotation of two power-rods 69c to the left, and two power-rods 96c to the right in opposite directions to each other, wherein the two opposing worm-wheels 69a inside axle-box 74 are rotating in opposite directions as well, to secure a balanced movement of both large cylinders 67 with two worm-wheels 69a on each side, to move both large cylinders 67 in the same direction.

Articulated cars steering: The distances between the electromagnetic-sensor[s] (FIG. 1, 10) in front of the locomotive and every axle in the articulated cars is pre-programmed in controller 100. Utilizing Multi-objective Optimization Design (MOOD) procedures, controller 100 may compute the locomotive instant [or changing] speed with the distance to each axle in the railway-vehicle to obtain the precise time every wheelset along the railway-vehicle is expected to reach the beginning point of the divergence from straight; go through the exact geometry of the comprehensive curve; to the point of exit.

When an articulated car bogie configured with electric traction-motors reached the beginning of the curve—after applying different torque and different speed to opposing electric traction-motors—controller 100 actuates steering-motor 25 (FIGS. 11c, 12c, 13c, 14c and 15c) at the projected time when each bogie may have reached the beginning of the curve, to steer the opposing electric traction-motor-wheel-aggregates (FIGS. 19a, 19b, 20 and 21) in each bogie, until the corresponding wheels face 90° to the rail, and to the geometric turning center. This precision is achieved as a result of continuous loop between yaw-sensor 9, controller 100 and electric traction-motor 25 in each bogie along the railway-vehicle. The wheels may return to straight or whatever position when the wheels are projected to exit the curvature.

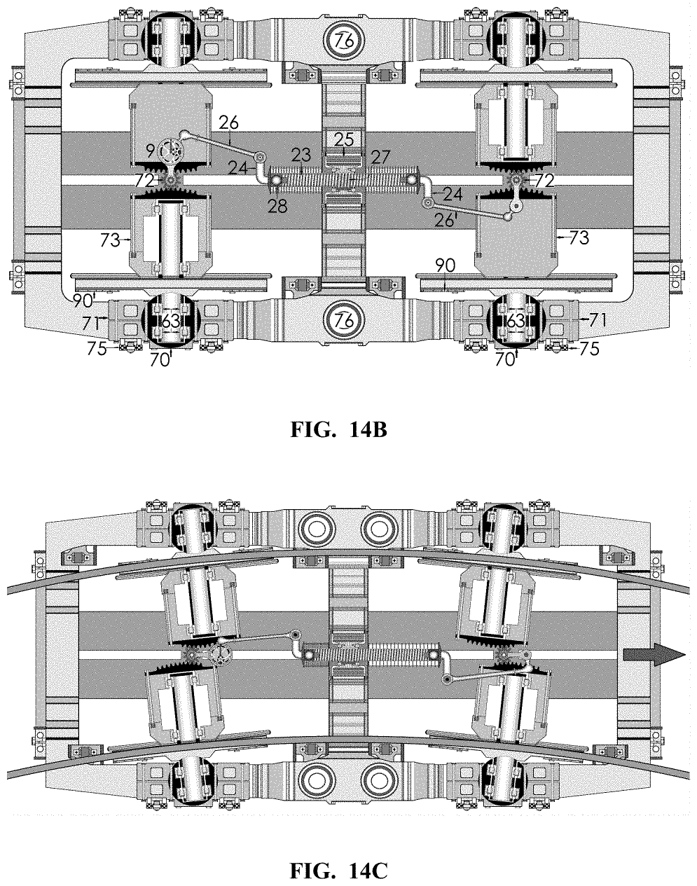

In articulated cars without electric traction-motors (FIGS. 11 and 14), controller 100 may actuate steering-motor 25—in each bogie at the projected time when each bogie arrives at the beginning of the curvature—to move opposing steering aggregates 73 in each bogie, until the corresponding wheels faces 90° to the rail and to the geometric turning center.

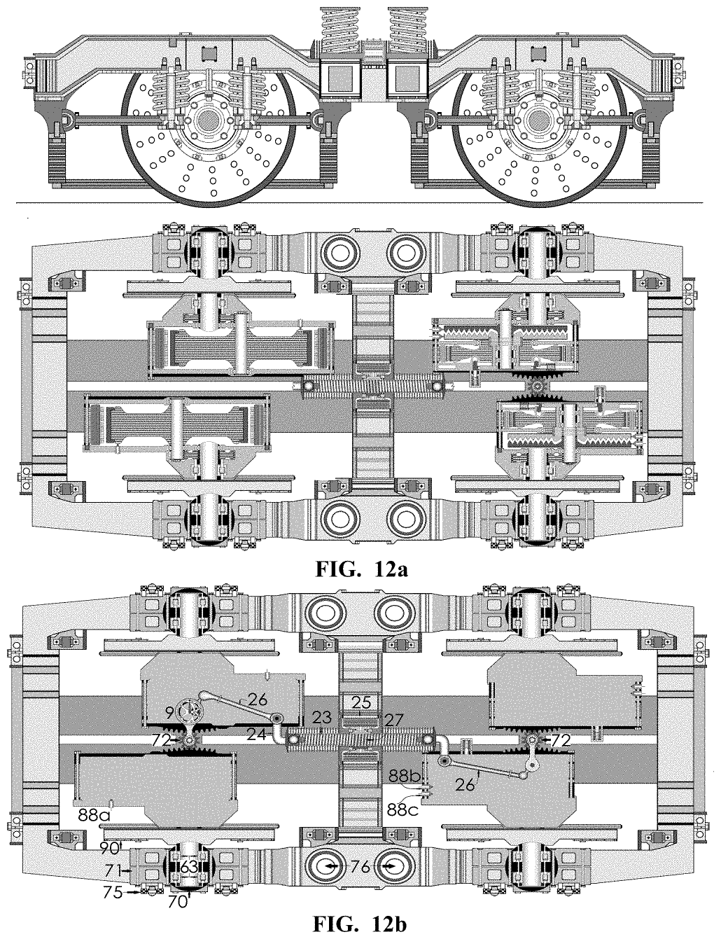

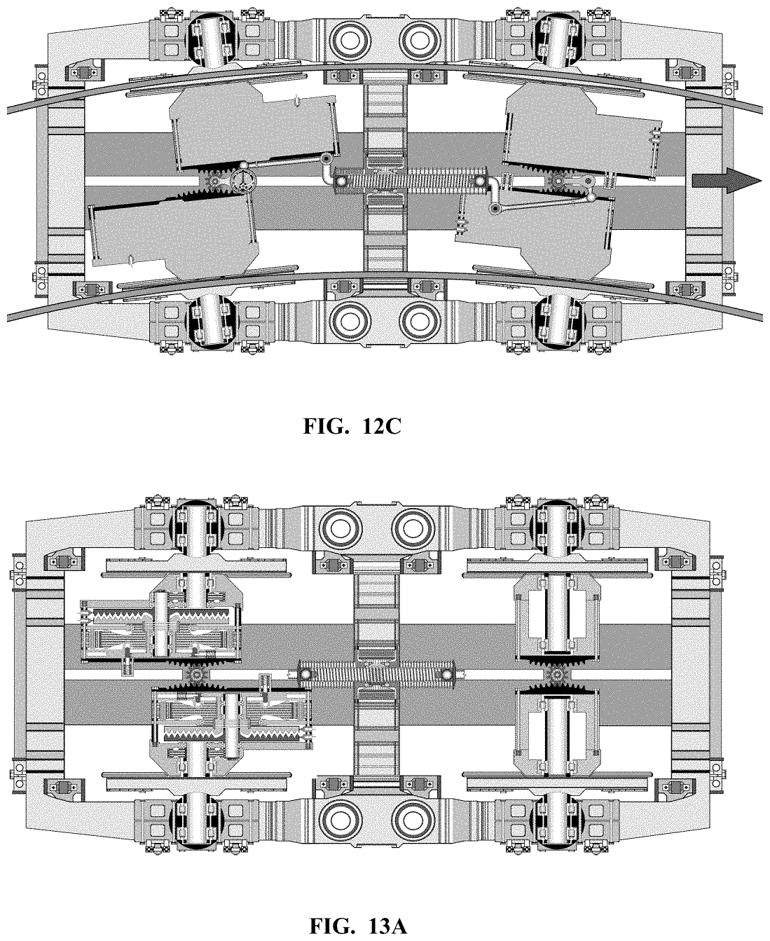

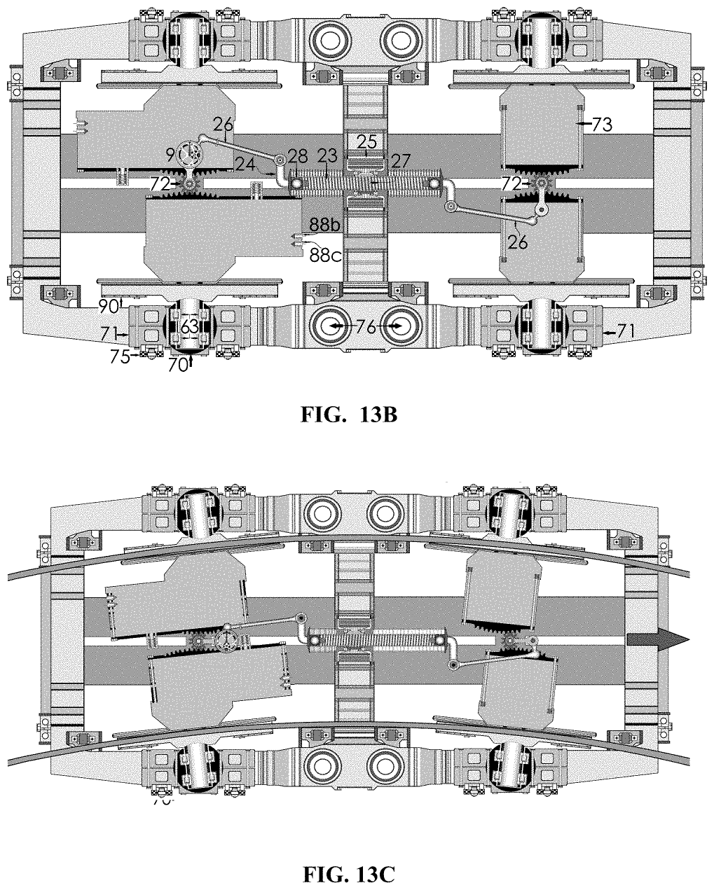

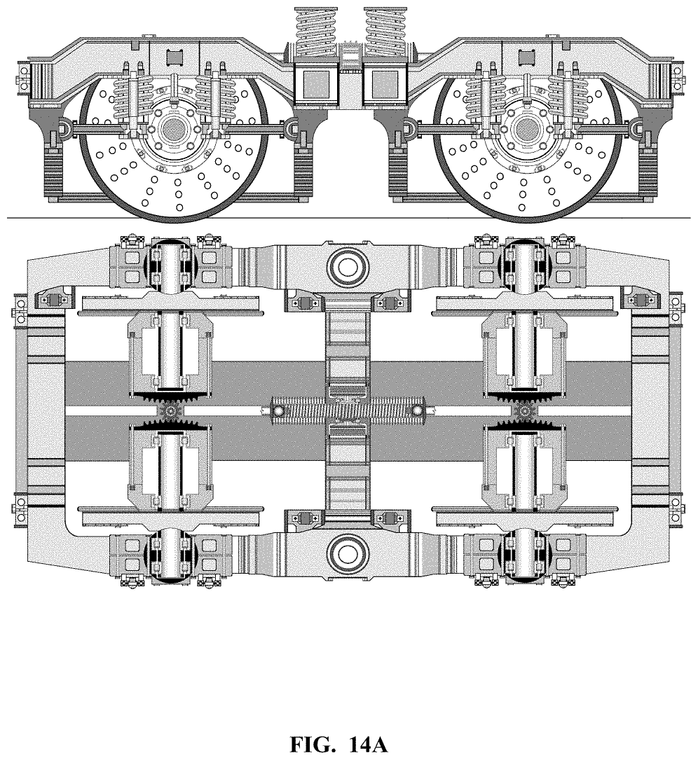

For instance, a railway-vehicle that travels at 80 km/h or 22.22 m/sec, and the last wheelset is 200 meters from the front of the locomotive. In about 9 seconds, controller 100 may increase the torque and speed of the wheels on the opposite side to the turning center—if an electric traction-motors is installed—(FIGS. 12 and 13), whereas instantly actuate steering-motor 25 in said bogie to force all wheels in said bogie to face 90° to the track and to the geometric turning center, in a precise loop maneuver between yaw sensor 9, controller 100 and electric traction-motor 25. Wheels without electric traction-motors are steered without initial support of the different torque and speed application because these structures are typically not torrential (FIGS. 11c, 14c) as ones with electric traction-motors (FIGS. 12c, 13c and 21).

### A Fail Operational Steering-Systems

A major stumbling block for electronic steering, or ‘steer-by-wire’ is NHTSA's [U.S. National Highway Transportation & Safety Administration] rulings. NHTSA forces steering suppliers to migrate from Fail Safe Systems to Fail Operational Steering Systems. A Fail-Safe or Fail-Secure Device is one that, in the event of a specific type of failure, responds in a way that will cause no harm, or at least a minimum of harm, to other devices or to personnel. This application discloses a system (FIG. 28) that detects and fixes potential steering malfunctions, update and validate in-railway-vehicle software on-line, to minimize the probability of malfunction. This disclosure emulates human's double-helix DNA repair ‘technology,’ wherein a defective section in one of the DNA strand is ‘fixed’ by reading and interpolating the ‘healthy’ opposing section in the other strand. This application discloses a system that if any wire anywhere in the steering system, or a yaw-sensor is faulty, controller 100 is programmed to interpolate the reading of the yaw-sensor in the next bogie, stay in a loop with the next bogie, and apply a corrected actuation to the electric steering-motor in the defective bogie, to keep the steering procedure within safe range of 1% error, while activating warning signal. This application discloses a fail-assist system that fully complies with NHTSA's ‘fail operational systems’ for electric steering.

### Integrating Traction-Motors into the Braking Course of Action

The third mobility scenario is when a railway-vehicle moves into a braking procedure, which involves an intricate, multi-level fast-deceleration control, to the final stop. Since the speed and stop of railway-vehicles is not autonomous as steering, braking-mode starts when the locomotive engineer moves stop-lever 19 (FIG. 1) to any point between “0” and “10,” which represents the brake intensity-level. When stop-lever 19 and speed-lever 18 are in operation, the analog data is converted into digital information to maintain digitalization across the board.

Depending on two variables: (a) the locomotive engineer's braking intensity (lever 19, FIG. 1); (b) the instant velocity (lever 20); and the railway-vehicle weight, controller 100 utilizes multi-objective optimization algorithm to compute the kW size of electric traction-motors to be coupled to wheels to first, manage the railway-vehicle last-deceleration' phase; and elect the electric traction-motors that must be coupled to wheels to produce the computed kW braking-power. All or less than all electric traction-motors in the locomotive and in the articulated-cars may participate in the ‘fast-deceleration’ phase, while generating electrical energy. The electric traction-motors that were coupled, start to operate as generators, when the wheel's RPM, e.g., the electric traction-motors rotor RPM is faster than the sinusoidal current in electric traction-motors stators. At this point coupled electric traction-motors converts the railway-vehicle mammoth kinetic energy into electric energy wherein controller 100 may direct electric energy to battery energy-storage 14, 15 or to ultra-capacitors energy-storage 16, 17 or both (FIG. 1).

During the regenerative braking mode [charge sustaining], controller 100 is configured to control DC/AC voltage inverters 42, 44, 46 and 48 (FIG. 1) in the front bogie through control lines 49a—and corresponding voltage inverters in the rear bogie through control lines 49b—to invert the AC voltage received from the corresponding electric traction-motors 51, 52, 53, 54, 55 and 56 in the front bogie into a DC voltage to be supplied through lines 43 and 45 to DC bus 33 and 32, respectively [rear bogie electric traction-motors are not shown].

Controller 100 is further configured to control switching bi-directional DC/DC converters 21 and 22 in the front bogie (FIG. 1); and the corresponding bi-directional DC/DC converters in the rear bogie to buck voltage of DC bus 33 and 32 in the front bogie and the corresponding DC bus in the rear bogie and supply the bucked voltage to the respective energy storage units.

Longitudinal railway-vehicle dynamics was probably firstly motivated by the desire to reduce longitudinal oscillations in passenger railway-vehicles and in so doing improve the general comfort of passengers. The most important component in any longitudinal railway-vehicle dynamics, especially during fast-deceleration, is the changing distance between articulated cars, called the ‘free slack.’ To ensure a safe distance between wagons, this disclosure comprise plurality of newly developed ‘Electronic-Couplers’ (FIGS. 1 and 27, 119) to connect all wagons, and at the same time monitor and transmit to controller 100 the instantaneous changes from ‘free slack’ among all articulated cars. Controller 100 utilizes multi-objective optimization design (MOOD) procedures to compute the sensed information from all electronic-couplers 119; establish the multi-level control-needs to integrate the coupled electric traction-motors in the complex, multi-wagon braking procedure; whereas utilizing in the process an uneven actuation of electric traction-motors and electric brake-calipers to accomplish a perfectly controlled balanced fast-deceleration, to the final stop.

The paramount concern of locomotive engineers during braking, is to avoid a “run-in” scenario (FIG. 26) where articulated cars are progressively impacting each other as the railway-vehicle compresses-in during braking. One or more articulated cars may become uncoupled or broken away, and then climbing the next car in the course of uncontrolled braking procedure. The second concern is to avoid a “run-out” scenario where wagons are extended to the extreme of a ‘free slack’ connection as the railway-vehicle stretches. One or more articulated cars may become uncoupled or broken away.

The second major predicament taken under consideration is the fact that a railway-vehicle may be 350-meter-long, weighing 800 to 5000 tons or more and it may take a couple kilometers to stop it safely. Operation of larger railway-vehicles meant that the energy consequences for stopping a railway-vehicle become more significant. For these reasons, longitudinal railway-vehicle dynamics is a primary consideration during braking. Therefore, it includes the motion of railway-vehicle as a whole, and a few relative motions between individual articulated cars.

### Electronic-Couplers

When 12 or 18 articulated cars are connected with traditional couplers, and only about 6 or 9 articulated cars are equipped with electric traction-motors; a “run-in” and “run out” scenarios are inevitable, not only during braking procedures but also during everyday forward traction and deceleration procedures. Since the locomotive engineer, while sitting in the locomotive cabin is unable to see and fix a “run-in” and “run out” problems. This application discloses a replacement for the traditional, mechanical couplers. An electronic-couplers (FIG. 27) comprising an IC hall-effect sensors 116, functions as a monitoring-devices that informs controller 100 about the instant distance between every two wagons in relation to the ‘free slack’ set-point, i.e., 12 or 18 electronic-couplers 119 (FIG. 26) monitor the instant status of all articulated cars' ‘free slack’ along the railway-vehicle.

To continuously correct any deviations from the ‘set-point,’ controller 100 may actuate certain electric traction-motors and activate certain brake-calipers to maintain all wagons at optimal ‘set-point’ for best dynamics. Electronic-coupler 119 is merely a mechanical coupler between two articulated cars with an electronic monitoring device that informs controller 100 about the instant position of IC hall-effect sensor 116 in relation to measurement-plate 220, with which controller 100 may interpolate the space between articulated car 113 (FIG. 1), where coupler 119 assembly is installed, and articulated car 114 behind.

FIG. 26(a) represent the set-point of a draft gear shaft 111 [a small square below hall-effect sensor 116], which represent the ideal gap between the two articulated cars 113 and 114 (FIG. 1). FIG. 26(b) represents a “run-in” scenario, wherein two connected articulated cars are too close to each other; and FIG. 26(c) represents a “run-out” scenario, where two articulated cars are stretched, too far apart from each other. All (a), (b) and (c) scenarios are instantly transmitted in a loop to controller 100 from all couplers 119 assemblies in each articulated car along the railway-vehicle.

It is imperative to understand that traditional hydraulic or air braking systems could not be implemented in the instant disclosure because:
hydraulic or air braking systems are inefficient;
hydraulic or air braking systems utilize mineral oils; and
hydraulic or air braking systems are not controllable as electric brake-calipers.

Every electric traction-motor in system 10 is equipped with at least one speed (RPM) sensor 88a (FIGS. 16) and electric traction-motors with electronic-clutches are equipped with two speed (RPM) sensors 88b, 88c (FIG. 17). To bring all electronic-coupler 119 assemblies to the set point (FIG. 26(a)), i.e., to place all articulated cars in the ideal ‘set-point’ position, controller 100 may act in three different ways:
In the first phase of braking, in a loop with every individual electric traction-motor speed (RPM) sensors, controller 100 verifies that all electric traction-motors decelerate to a specific [RPM] speed—computed and corrected in reference to the electric traction-motor-gear to wheel-ratio—to maintain deceleration with uniform angular speed of all wheels along the railway-vehicle to prevent a “run-in” scenario where articulated cars are compresses-in, or a “run-out” scenario where articulated cars are reaching the extended extreme of connection ‘free slack’ as the railway-vehicle stretches. As a result of the enormous weight differences among articulated cars, controller 100 is not always successful in maintaining all coupler assemblies 119 at “set-point.”
The second phase of braking is where coupler assemblies 119 approach a “run-in” scenario (FIG. 26(b)). Controller 100 raises in a fraction the speed of electric traction-motors in articulated car 113 (FIG. 1), and the articulated car in front of 113 if articulated car 113 is not a power wagon; and simultaneously controller 100 intensifies in a fraction the brake-caliper's pressure in articulated car 114 behind. The same procedure is executed in all articulated cars along the railway-vehicle, where all articulated cars in front of car 113 are treated as car 113; and all cars behind car 114 are treated as car 114. When sensor 116 (FIG. 26) reports to controller 100 that coupler 119 in articulated car 113 reached the ‘set-point,’ controller 100 returns to the first course of braking, which is maintaining the same angular-rotation of all wheels along the railway-vehicle.
The third phase of braking, where electronic-coupler assembly 119 goes into a “run-out” scenario (FIG. 26(c)), controller 100 reduces in a fraction articulated car 113 speed or articulated car in front of 113, if articulated car 113 is not a power wagon; and simultaneously controller 100 reduces in a fraction the brake-caliper's pressure in articulated car 114 behind. The same procedure is executed in all articulated cars along the railway-vehicle. When sensor 116 reports to controller 100 that coupler 119 reached the ‘set-point,’ controller 100 returns to the first phase of braking by maintaining the same angular-rotation of all wheels along the railway-vehicle.

At the end of the fast-deceleration phase, while the electric traction-motors continue to act as generators, depending on the railway-vehicle speed and the weight data entered, controller 100 calculates the needed braking-power to be apply and distribute among all electric disc-brake calipers along the railway-vehicle to bring the entire railway-vehicle into a complete, balanced stop. The railway-vehicle final stop comprises a complex involvement of the locomotive and several articulated cars all of which may have different weight that may require uneven braking-power.

To reach a secured, uniform, and safe complete stop, the electric-brake-intensity is distributed unevenly, in a linear power distribution among each set of brake-calipers along the railway-vehicle. The recommended initial utilization of brake-calipers may not start before the railway-vehicle decelerated to about 60 Km/h. Controller 100 may keep a linear, fractional elevated braking-intensity level through all installed electric brake-calipers, beginning with the last articulated car until it reaches the locomotive, which is computed to keep all articulated cars at the ‘set-point’ status.

### System 10 Accident Prevention

Derailments in the railway industry became somehow rare today but they are still happening despite all kind of electronic gadgets that are trying to prevent such unfortunate incidences. When those accidents materialized, the majority of cases were caused by human error. A locomotive engineer has no control over the steering in system 10 because this application discloses a sophisticated steering system that is fully autonomous, with controller 100 dominance over torque, speed, and angle position of all wheels, which leaves the locomotive engineer only the control of the railway-vehicle speed (FIG. 1, 18) and the control of the railway-vehicle deceleration to a final stop (FIG. 1, 19).

Controller 100 is configured with electronic torque and speed control over all electric traction-motors and over all electric steering-motors operation as entered into controller 100 data-base. While controller 100 cannot prevent the locomotive engineer from choosing any desired speed (FIG. 1 lever 18) in combination with unsafe turning angel; controller 100 is configured to utilize multi-objective optimization design (MOOD) program; to include the locomotive and all articulated cars center of gravity information into the computation, and generate an algorithm that delivers a procedure to maintain in any combination of turning angle and railway-vehicle speed, a safe forward motion, below a computed threshold-point that may endanger the railway-vehicle stability or cause derailment even though the locomotive engineer may have pushed lever 18 to maximum.

What is claimed:

1. An electric scalable tractive power system for a railway-vehicle, comprising:
a plurality of electric traction-motors,
wherein the plurality of electric traction-motors is:
configured in groups of electric traction-motors,
coupled to wheels of the locomotive and selected articulated cars, and
designed with different power ratings and different high-efficiency ranges of operation;
further wherein each group of the groups is designed to overlap each other's high-efficiency range of operation while the railway-vehicle is changing speeds, to create a continuous, high-efficiency range of tractive-power from a forward-motion start of the railway-vehicle to a top-rated speed of the railway-vehicle,
further wherein selected group of the groups comprises:
an electronic controlled clutch configured to couple and de-couple each of the plurality of the electric traction-motors, within the each group of the plurality of groups, to and from the wheels as part of a scalable tractive power-control strategy;
a fully automated electronic clutch-system attached to selected electric traction-motors within the each group of the plurality of groups;
an electronic clutch-system configured to carry out coupling and decoupling of at least one of the plurality of electric traction-motors within the group of groups to and from the wheels by utilizing electronic, electromagnetic, and electro-mechanical procedures;
a battery-pack with at least one energy storage-unit coupled to a DC bus;
a secondary energy storage unit with numerous ultra-capacitor cells;
a flywheel;
a holistic controller comprising multi-objective optimization design (MOOD) procedures configured to:
determine power requirements to maintain railway-vehicle instant tractive effort;
elect a group of electric traction-motors from the groups that may produce a required tractive effort with best efficiency;
actuate at least one group of electric traction-motors from the groups;
identify, from the groups, a first group of electric traction-motors having specifications to produce instant speed and load requirements with lowest energy use up;
actuate and couple the identified first group of electric traction-motors to the wheels;
identify, from the groups, a second group of electric traction-motors configured to overlap a last portion of an efficiency range of the identified first group of electric traction-motors in order to produce a most efficient tractive effort requirement in acceleration or deceleration after the identified first group of electric traction-motors has reached its efficiency limits;
actuate and couple to the wheels a second group of electric traction-motors to carry out tractive effort requirements and simultaneously de-couple from wheels the identified first group of electric traction-motors.
compare tractive power of the second group of electric traction-motors to an instant tractive effort requirement;
identify from the comparison a remaining tractive effort requirement;
actuate a third group of electric traction-motors from the groups to produce the remaining tractive effort.

2. An electric scalable tractive power system for a railway-vehicle of claim 1, comprising:
a plurality of electric traction-motors permanently coupled to wheels of a locomotive and to selected wheels of articulated cars are configured without clutches;
a plurality of electric traction-motors permanently coupled to wheels of a locomotive and to selected wheels of articulated cars are rotating whenever the railway-vehicle is in motion;
wherein, as part of the scalable tractive system, the number of permanently coupled electric traction-motors, and the sum of the tractive power of permanently coupled electric traction-motors may represent the minimum tractive-power requirements to drive an empty railway-vehicle on a flat-trail to:
maintain an efficient, with minimum energy use-up.

3. The electric scalable tractive power system for a railway-vehicle of claim 1, comprising:
a plurality of electric traction-motors, coupled to wheels of a locomotive and to selected wheels in articulated cars is:
configured as an advanced configuration of independently rotating wheels (IRW);
wherein opposing electric traction-motors in a locomotive and in selected articulated cars may drive the wheels with different torque and different speed to assist and perfect the steering.

4. An electric scalable tractive power system for a railway-vehicle of claim 1, comprising:
a plurality of electric traction-motors configured with electronic-clutch systems as part of the scalable tractive power-control, comprising;
an electric traction-motor shaft secured to the wheel-side disc-clutch is:
configured inside the electric traction-motor rotor;
configured with spur- or helical-gear at the outer end; and
meshes with the inner wheel-axle spur or helical-gear to create an electric ‘traction-motor-to-wheel’ tractive power-module;
a two disc-clutch unit is:
configured with any form of matching concave indentation and convex projections that are fitted tight one inside the other when the wheel-side disc-clutch and the electric traction-motor disc-clutch are coupled;
a wheel-side disc-clutch is:
fixed permanently to the electric traction-motor shaft, and is:
rotating whenever the railway-vehicle is in motion;
wherein a wheel-side disc-clutch may act as flywheel when the disc-clutch is not coupled;
an electric traction-motor disc-clutch is configured with a cylinder attached to the back of the electric traction-motor disc-clutch, wherein the electric traction-motor disc-clutch cylinder is: configured with splines inside and outside to facilitate the forward movement of the electric traction-motor disc-clutch cylinder during coupling with the wheel-side disc-clutch and to facilitate the backward movement of the electric traction-motor disc-clutch during de-coupling from the wheel-side disc-clutch.

5. The electric scalable tractive power system of claim 1 further comprising:
a holistic controller is:
configured to utilize multi-objective optimization design (MOOD) procedures, wherein the holistic controller is programmed to:
identify from the groups a specific group of electric traction-motors that meets an instant tractive-effort requirement while using up the smallest amount of energy; and
split the instant tractive-effort between the groups.

6. The electric scalable tractive power system of claim 1 further comprising:
a holistic controller is:
configured to actuate all electric traction-motor groups at forward-motion start,
wherein the railway-vehicle is configured to travel from forward-motion start to about 100 Km/h in such a short time frame that may secure a safe maneuverability during future acceleration, deceleration, braking, or in any continuous and peak tractive-effort thereafter.
Configured to de-couple selected electric traction-motors from wheels, seconds after the railway-vehicle reached a cruising speed, to cut down in energy consumption.

7. An electric scalable tractive power system for a railway-vehicle, comprising:
a plurality of electronic controlled clutches, coupled to selected electric traction-motors:
wherein an electronic controlled clutch-system is configured to:
perform coupling and de-coupling of selected electric traction-motors to and from wheels in the locomotive and in selected articulated cars;
further wherein the electronic controlled clutches are fully automated within the railway-vehicle scalable tractive power system;
wherein electronic, electromagnetic, and mechanical procedures is utilized to carry out precision coupling and de-coupling of the electric motors.

8. An electronic controlled clutches of claim 7, comprising:
a two disc-clutches unit is:
configured with dog-teeth, claws-teeth or any other means of convex projections and concave indentation that fits perfectly tight one inside the other when the wheel side disc-clutch and the electric traction-motor disc-clutch are coupled;
a wheel-side disc-clutch is:
coupled permanently to the electric traction-motor shaft via teethed gear at the outer end of the electric traction-motor shaft that is meshed with the inner wheel axle teethed gear, and is rotating whenever the railway-vehicle is in motion;
an electric traction-motor side disc-clutch is configured with a cylinder as part of the back of the electric traction-motor disc-clutch;
a disc-clutch cylinder is:
configured with splines, molded inside and outside the cylinder to:
facilitate a forward movement of the electric traction-motor disc-clutch cylinder during a coupling procedure with the wheel side disc-clutch, and to:
facilitate a backward movement of the electric traction-motor side disc-clutch during a de-coupling procedure from the wheel side disc-clutch.

9. The electronic controlled clutches of claim 7 comprising:
a speed-sensor, monitoring the wheel side disc-clutch RPM; and
a speed-sensor, monitoring the electric traction-motor side disc-clutch RPM;
wherein the RPM readings of all-wheel side disc-clutches is continuously monitored and transmitted by electronic means to the holistic controller;
wherein the RPM readings of all electric traction-motors side disc-clutches is continuously monitored, and transmitted by electronic means to the holistic controller;
whereas prior to coupling of the two disc-clutches, the selected electric traction-motor to be coupled is inactive, and is not under load;
the holistic controller may actuate the selected electric traction-motor to be coupled by driving the selected electric traction-motor RPM to precisely match the RPM of the wheel side disc-clutch, in a fraction of a second.

10. The electronic controlled clutches of claim 7 comprising:
a holistic controller is:
configure to maintain a loop with each wheel-side disc-clutch speed sensor individually;
wherein the RPM information provided by a wheel side disc-clutch sensor provides the holistic controller with information to precisely compute the voltage and the proper modulation to be applied to the electric traction-motor to precisely match the wheel-side disc-clutch RPM;
wherein the holistic controller may bring an electric traction-motor disc-clutch RPM to precisely match the RPM of the wheel side disc-clutch just before coupling, to secure an optimal coupling.

11. The electronic controlled disc-clutches of claim 7 further comprising:
a holistic controller is:
configured to couple the electric traction-motor disc-clutch with the wheel side disc-clutch;
a first set of electromagnetic release-solenoids is:
configured with latches to secure the rear of the electric traction-motor disc-clutch cylinder in a de-coupled, stationary position;
a compressed spring is:
configured around the electric traction-motor disc-clutch cylinder, between the electric traction-motor rotor and the back of the electric traction-motor disc-clutch;
a holistic controller, in a loop with the RPM sensors of both disc-clutches just before coupling of the electric motor disc side to the wheel side disc-clutch is:
configured to actuate the electric traction-motor to precisely match the RPM of the electric traction-motor disc-clutch to the wheel side disc-clutch before proceeding with the coupling of the two discs;
further configured to actuate a first set of solenoids to:
pull with electromagnetic means the latches holding the electric traction-motor disc-clutch in a de-coupled, stationary position;
whereas actuating the first set of solenoids, it is:
triggering the release of an elastic-energy stored in a compressed large spring between the electric traction-motor rotor and the electric traction-motor disc-clutch;
wherein said large spring:
thrusts forward the electric traction-motor disc-clutch on the splines molded inside and outside the electric traction-motor disc-clutch cylinder;
whereas a secured coupling of the electric traction-motor disc-clutch with the wheel side disc-clutch is carried out;
whereas an electric traction-motor rotational energy is transferred to wheel.

12. The electronic controlled clutch of claim 7 comprising:
a holistic controller is:
configured to compute when certain electric traction-motor group is no longer operating in its optimal efficiency limit; or an electric traction-motor group is no longer required when the railway-vehicle tractive efforts requirements decrease, or when another electric traction-motor group is coupled;
configured to de-couple the electric traction-motor disc-clutch from the wheel side disc-clutch;
a second set of solenoids is:
configured to pull the electric traction-motor disc-clutch cylinder from a coupled position to a de-coupled position with electromagnetic means;
the holistic controller is:
configured to actuate the second set of electromagnetic solenoids to overcome the elastic energy in a large spring placed between the electric traction-motor rotor and the electric traction-motor disc-clutch to:
pull and de-couple the electric traction-motor disc-clutch from the wheel side disc-clutch;
whereas the holistic controller is further configured to:
disconnect the power supply to the de-coupled electric traction-motors;
the holistic controller is further:
configured to activate the first and the second sets of solenoids at the same time;
whereas both solenoids are actuated, the first solenoid set pulls the locking latch up to afford the second set of solenoid enough room to pull the electric traction-motor disc-side cylinder all the way back to a locking position;
whereas the springs inside the first set of solenoids:
push-down the set of latches, to lock-down the electric traction-motor disc-clutch cylinder in a secured, de-coupled, and inactive position.

13. a plurality of energy resources for a railway-vehicles:
an energy storage unit[s] comprising:
a battery-pack energy storage with at least one energy storage-unit, coupled to a DC bus;
a secondary energy storage with plurality of ultra-capacitors, coupled to a DC bus;
a third energy storage-units with a flywheel, comprising power levels greater than 3 MW and electricity storage capacities greater than 5 MWh, may use radial gap magnetic bearings to store kinetic energy, coupled to a DC bus;
an energy producing unit[s] comprising:
a fuel-cell coupled to a selected electric traction-motor and to a DC bus;
an array of photovoltaic cells installed on top and along the side of articulated cars and trailers, coupled to a DC bus;
a holistic controller, comprising power management logic is:
configured to monitor and manage the state-of-charge in all energy storage units, which includes voltage and current sensing capacities of all battery-cells and all ultra-capacitors and flywheels.

14. A railway-vehicle plurality of energy resources of claim 13, comprising:
a secondary energy storage unit with plurality of ultra-capacitor cells coupled to one another;
wherein every single capacitor-cell may have a capacitance between 500 and 3000 Farads, or greater;
wherein a significant starting and acceleration tractive-effort is required in forward motion starts and during accelerations, which applies to all sizes of railway-vehicles;
a holistic controller is:
configured to deliver the electric energy during forward motion starts and during accelerations from ultra-capacitor energy storage system to electric traction-motors to:
provide instantaneous power; and to:
complement the battery-packs storage units that suffers fast deterioration when repeatedly providing quick bursts of power in frequent start-stop applications, mainly in commercial, inter-city and freight railway-vehicles, and at lower temperatures.

15. The tractive-system with electric-motors may operate as regenerative system, comprising:
a holistic controller is:
configured to couple all or less than all de-coupled electric traction-motors to wheels, to:
assist the railway-vehicle in generating additional electricity in all stages of slowing down with the assistance of all or less than all electric traction-motors;
configured to reconnect the power supply to a de-coupled electric traction-motors just before coupling an electric traction-motors in a locomotive or in articulated car wheels;
wherein an electric traction-motor is:
operating as a generator to produce electric energy;
wherein the regenerated electric energy is routed to a bi-directional DC/AC inverters;
a holistic controller is further:
configured to control all be-directional DC/AC voltage inverters and to:
convert AC voltage received from electric traction-motors during regenerative braking into DC voltage and supply the DC voltage to a corresponding DC bus;
configured to control all bi-directional DC/DC converters to buck voltage of the respective DC bus and supply the bucked voltage to a respective energy storage units;
configured to utilize multi-objective optimization design (MOOD) programs to distribute braking efforts unequally among all electric traction-motors, and among all electric brake-calipers to:
provide optimal dynamic stability, in wet weather, in turning procedures, and in any other driving conditions that require uneven braking procedures for optimal stability;
whereas wastage of brake-discs and brake-pads is curtailed.

16. An electric scalable tractive power system integrated into all-wheel steering system for a railway-vehicle, comprising;
a track divergence-sensor, located in front of the locomotive, utilizes an array of inductive metal detectors;
wherein the track divergence-sensor is:
configured to identify with electromagnetic means the upcoming deviation of the track ahead of the locomotive, and transmit the information to the holistic controller by electronic means;
a GPS-sensor, connected to a GPS-receiver connected to the holistic controller is:
configured to provide the holistic controller the commencing point of the track divergence from straight;
provide the exact geometry of the comprehensive curve; and
provide the point of exit from the curve to a straight track;
a single steering-motor fixed to the frame of a bogie is:
configured in each bogie in the locomotive and in all articulated cars;
wherein a single steering-motor actuates all-wheels in 1- 2- or 3-axle bogies configurations;
a large ball-bearing screw is:
driven by a steering-motor with a spur- or helical-gear, with belt, or with chain configuration, wherein the large ball-bearing screw:
converts the rotational energy of the steering-motor into linear movement of the large ball-bearing screw to the left or to the right;
a ball-bearing screw head is:
configured in one end of a large ball-bearing screw in a 1-axle bogie configurations, and in both ends of ball-bearing screw in 2 and 3 axle bogie configurations;
a steering-rod is:
configured in one end with a convex form that encapsulates the ball-bearing screw head to form a ball-and-socket-joint with the steering-rod;
whereas the other end of the steering-rod is connected with a simple joint to one end of a tie-rod;
a steering tie-rod is:
configured with length-adjustment nut, and is connected to a fixed short extension perpendicular to the tie-rod,
whereas the other end of the short extension is inserted through a yaw-sensor cylinder;
a single yaw-sensor is:
configured in 1, 2 or 3 bogies in a locomotive and in each bogie of all articulated cars;
configured with two main parts:
a yaw-sensor housing fixed to the top of a long spur- or helical-gear column, and
a yaw-sensor cylinder is:
configured inside a yaw-sensor housing;
whereas the tie-rod short extension is inserted into the yaw-sensor cylinder;
wherein any incremental angular change between the yaw-sensor cylinder and the yaw-sensor housing is proportional to the change of the angle of all-wheels within a specific bogie;
a yaw-sensor is further:
moving to the left or to the right, which triggers movement of a pointer-head on the face of the yaw sensor,
whereas transmitting the monitored change of resistance on the face of the yaw sensor by electronic means to the holistic controller;
the holistic controller is:
interpolating the change of resistance readings into the computation, with which the holistic controller generates an instant position for each wheel in a 1, 2 or 3 axle bogie configurations:
a long, spur- or helical-gear-column is:
meshed with a molded gear-rack on the outer-walls between two traction-motor-wheel-units;
wherein any incremental rotation of the yaw-sensor housing triggers the same incremental angular rotation of the long spur- or helical-gear-column that is:
moving the two-opposing electric traction-motor-wheels-units into a proportional incremental rotation,
wherein the two opposing wheels are positioned precisely perpendicular to the rail and perpendicular to the geometric turning center;
a large steering-ball is:
configured in each wheel axle-box, located in the primary suspension of each bogie;
whereas the outer wheel-axle is centrally positioned inside a large steering-ball, it is:
configured with two or more large ball-bearings;
whereas a large steering-ball is not rotating, the large steering-ball is:
configured to afford incremental movements of the outer wheel-axle to the left or to the right inside the steering-ball whenever the wheel is steered.

17. All-wheel steering system for railway-vehicles, integrated with the electric traction-motors of claim 16, comprising:
a holistic controller, while in a loop with the yaw-sensors and with the electric steering-motors in each bogie is:
configured to utilize multi-objective optimization design (MOOD) procedures to:
analyze various trade-offs and build a robust machine learning models;
evaluate the information provided from:
the track divergence sensor,
the GPS sensor,
all bogies yaw-sensors, and
all electric traction-motor RPM sensors to:
compute the time each wheel may reach the beginning and the end of a curve;
compute the angle position and speed of each wheel along the railway-vehicle:
and apply the computed angle, speed, and torque when each wheel reaches the curve;
a holistic controller is further configured to:
integrate selected electric traction-motor in the steering processes while applying different torque and different speed to opposing electric traction-motors to:
assist in the ‘initial push’ of the steering-motors.

18. All-wheel steering system for railway-vehicles, integrated with the electric traction-motors of claim 16, comprising:
a single steering-motors for 1 or 2-axle bogies, primarily utilized in articulated wagons is:
configured as an efficient electric steering-motor,
fixed to the bogie's frame, and
wrapped around the center of a large ball-bearing screw;
a steering-motor rotor is:
configured as a big nut with threaded hole:
rotating smoothly around the ball-bearing screw due to ball-bearings captured between the threaded nut and the ball-bearing screw threads to:
minimizes friction between the ball-bearing screw and the threaded nut;
wherein the rotor of the steering-motor is:
rotating around the ball-bearing screw;
whereas the rotational energy is:
converted into linear motion of the ball-bearing screw to the left or to the right;
Any configuration of electric-motors may be fitted to convert rotational energy into liner movement of the ball-bearing screw.

19. All-wheel steering system for railway-vehicles, integrated with the electric traction-motors of claim 16, comprising:
a three-axle bogies steering is primarily configured as a 2-axle bogies steering for the front axle and for the rear axle;
the two center wheels in the 3-axle bogie are not actually steered, they are:
proportionally forced in a complex procedure to the opposite side of the turning center to form a perfect two-turning-lines with the front and the rear wheelsets;
a large, centrally located electric steering-motor is:
fixed to the frame of the bogie, and is primarily installed in locomotives;
wherein part of the steering-motor rotational energy is:
transferred to a large ball-bearing screw by spur- or helical-gears, by belt or by chain to:
steer the front and the rear wheel axles as in 2-axle bogie configuration;
configured with a long rotor shaft, exiting the steering-motor housing in both directions to the left and to the right,
wherein the two outer-ends of the steering-motor shaft are:
coupled to two bevel-gears;
wherein each steering-motor-shaft outer-end bevel-gear is;
meshed with two additional, opposing bevel-gears, coupled to two power-rods;
a power-rod is:
configured with a bevel-gear in one end and with a worm gear at the other end;
a worm-gear is:
meshed with a corresponding worm-wheel;
a worm-wheel is:
meshed with a gear-rack molded on both sides of a steering-cylinder inside the central, long axle-box of a 3-axle bogie;
a steering-cylinder is;
configured with a gear-racks on both sides of the steering-cylinder,
wherein the cylinder is:
wrapped around the outer-end of a center wheel-axle with more than one large ball-bearings;
a worm-wheel positioned between a worm-gears and the gear-rack on both sides of the steering-cylinder is:
secured with a power-rod that runs through the center of the worm-wheel, perpendicular to the power-rods with the bevel-gear on one end and the worm-gear at the other end,
a worm-wheel power-rod is:
embedded with one end into a bearing, fixed into the bogie roof;
whereas the other end is:
embedded into a bearing fixed into the bogie floor.

20. All-wheel steering system for 3-axle bogie in railway-vehicles, integrated with the electric traction-motors of claim 16, comprising:
a large electric steering-motor actuates simultaneously three different steering axles, and with only one long shaft, sticking out to the left and to the right of the electric steering-motor;
wherein each steering-motor-shaft end is:
rotating two power-rods to the left of the steering-motor-shaft end; and
rotating two power-rods to the right of the steering-motor-shaft end, in opposite directions to each other,
wherein two-opposing worm-wheels inside each of the two, long axle-boxes are:
rotating in opposite directions to each other, to secure a balanced movement with two worm-wheel on each side of the large wheel-axle outer-end cylinder;
a centrally located large electric steering-motor is:
positioning in geometric precision, 6-different-wheels in 6 different angles to:
travel through a curve with virtually 100% dynamic efficiency.

21. All-wheel steering system for railway-vehicles, integrated with the electric traction-motors of claim 16, comprising:
a single yaw-sensor in each bogie along the railway-vehicle;
a yaw-sensor housing is:
configured with molded gear-rack, facing the inner side of the upper quarter of the yaw-sensor housing;
a cylinder, occupies three-quarter of the lower part inside the yaw-sensor housing;
a tie-rod is:
connected in one end to a steering-rod and the other bendable end is inserted inside the yaw-sensor cylinder, and fixed with a lock-nut at the other side of the cylinder;
a multi-gear system is:
comprising the inner part of the yaw-sensor mechanisms:
a first spur- or helical-gear is:
meshed with the molded gear-rack in the inner side of the yaw-sensor housing;
a second spur- or helical-gear is:
meshed with the first spur- or helical-gear, and is configured with shaft inserted to the center top of the cylinder inside the yaw-sensor housing;
a pointer is:
fixed at the top of the second spur- or helical-gear shaft, and the outer-end of the pointer is in a continuous electrical contact with a half circle variable resistance to the left, and a half circle variable resistance to the right, which is;
configured on the yaw-sensor face;
an IC hall-effect sensor may replace the pointer function if hefty vibrations may cause interrupted wheel-position sensor readings.

22. All-wheel steering system for railway-vehicles, integrated with the electric traction-motors of claim 16, comprising:
a steering actuation sequence in each bogie along the railway-vehicle begins when the holistic controller:
actuates the steering-motor, which is:
transferring the rotational energy to the large ball-bearing screw;
wherein clockwise or counter-clockwise rotation of the large ball-bearing screw:
pushes or pulls a steering-rod;
a steering-rod is:
pushing or pulling a tie-rod;
a tie-rod is:
configured with a short bend extension, inserted inside the yaw-sensor cylinder;
a yaw-sensor cylinder, while is:
pushed or pulled by a bent tie-rod extension, is:
triggering proportional angle change of the wheels within the corresponding bogie, wherein the yaw-sensor angular-change limit may be 90°,
whereas the railway-vehicle wheels angular-change limit may be 12° to 15°;
a tie-rod extension is:
configured to push or pull the yaw-sensor cylinder;
wherein the yaw-sensor cylinder makes an incremental angular rotation, which:
changes the previous angle between the yaw-sensor cylinder, and the molded gear-rack inside the wheel-position sensor housing, which is:
initiating a rotation of the first gear inside the wheel-position sensor housing;
a second gear is:
actuated by the first gear;
wherein the second gear shaft makes an incremental angular rotation;
a pointer fixed on top of the second gear shaft is:
moving the pointer head in increments on the variable resistance on the wheel-position sensor face;
the holistic controller:
interprets the changes in resistance provided by the yaw-sensor, which:
specifies the instant position of the yaw-sensor, then:
the holistic controller:
interpret the electronic transmission into the specific angle of each wheel within the corresponding bogie, in relation to straight forward.

23. All-wheel, steering system for railway-vehicles of claim 16, comprises:
a holistic controller is:
configured with a ‘fail-safe system’
wherein malfunction of one of the yaw-sensors, or in case of broken, disconnected, or malfunctioning wires;
the holistic controller is:
configured to emulate ‘repair proceedings’ in human's double-helix DNA by:
utilizing the yaw-sensor reading from the bogie in front or behind the bogie with a defective yaw-sensor; and
interpolate the reading of the front or the rear bogie yaw-sensor, subject to the distance and the speed of the railway-vehicle; and
generate the defective side yaw-sensor reading to keep the railway-vehicle in a ‘fail safe system’ configuration:
whereas reducing the velocity of the railway-vehicle to a safe speed, to keep the affected wheels within a safe range of less than 1° error,
a holistic controller is:
further configured to generate a warning signal to alert the locomotive engineer of the malfunction.

24. A railway-vehicle scalable traction system, integrated in the braking system, comprising:
an intricate, fast-deceleration system, generating electric energy, comprising:
a holistic controller is:
configured to converts the locomotive engineer stop-lever analog signal into digital signal, and is:
configured to utilize multi-objective optimization design (MOOD) procedures to compute the energy size needed, and the number of electric traction-motors to be coupled to wheels to initiate a fast decelerating-procedure;
configured to first manage the railway-vehicle ‘fast-deceleration’ phase;
wherein selected de-coupled electric traction-motors is:
coupled to the wheels to produce the computed kW braking-power;
the holistic controller is:
further configured to diminish the current supply from the bi-directional DC/AC inverters to the electric traction-motor, while the role of the traction-motors changes from driving the wheels, into being actuated by the wheels through the massive kinetic energy of the railway-vehicle;
wherein the electric traction-motors coupled to the wheels is:
acting as generators;
converting kinetic energy into electric energy, and
decelerating the railway-vehicle.

25. A railway-vehicle scalable traction system, integrated in the braking system of claim 24 comprising:
a plurality of braking-calipers is:
actuated with electric energy;
a holistic controller is:
configured to control all be-directional DC/AC voltage inverters to convert the AC voltage received from the electric traction-motor during regenerative deceleration into a DC voltage and supply the DC voltage to the corresponding DC bus;
configured to control all bi-directional DC/DC converters to:
buck voltage of the respective DC bus and supply the bucked voltage to selected energy storage units, since the generated low-voltage cannot be routed to the extremely high voltage in the railway-vehicle overhead-lines.

26. A railway-vehicle scalable traction system, integrated in the braking procedure of claim 24, comprising:
a holistic controller is:
configured to utilize multi-objective optimization design (MOOD) program to:
distribute a balanced deceleration to a final stop, involving all or less than all electric traction-motor , and
actuate all or less than all electric brake-calipers to provide a longitudinal dynamic stability, in wet weather, in curves and in any other driving conditions that requires uneven actuation of electric traction-motor and electric brake-calipers, whereas lowest energy use-up and maximum dynamic stability is achieved;
whereas wastage of the brake-pads and calipers is curtailed.

27. A railway-vehicle scalable traction system, integrated in the braking procedure of claim 24, comprising:
a holistic controller utilizing multi-objective optimization design (MOOD) procedures is:
configured to establish multilevel controls in plurality of articulated cars to:
integrate a complex braking procedure with selected electric traction-motors;
configured to unevenly actuate selected brake-calipers to accomplish a perfectly balanced fast-deceleration, to the final railway-vehicle stop;
the holistic controller may act in 3 different ways to maintain all articulated cars in an ideal ‘free-slack’ position;
in the first phase, which is the fast phase of braking,
the holistic controller is:
configured to couple to wheels all electric traction-motors that are de-coupled;
actuate all coupled electric traction-motor to decelerate at a specific, and balanced computed speed,
whereas monitoring and correcting the electric traction-motors RPM in reference to the electric traction-motor gear-to-wheel-ratio to:
maintain a uniform angular speed of all-wheels along the railway-vehicle to prevent a “run-in” scenario where articulated cars are compresses-in, or a “run-out” scenario where articulated cars are reaching the extended extreme of the ‘free-slack’ connection;
whereas entering into computation the weight differences among articulated cars;
the holistic controller is:
configured to maintain all electronic coupler units between all articulated cars at optimal ‘free-slack’;
in the second phase of braking, when the electronic-coupler approach a “run-in” scenario, the holistic controller is:
configured to raise-in-a-fraction the speed of the electric traction-motor in all articulated cars in front of the electronic-coupler; and simultaneously,
intensify in a fraction the brake-caliper pressure in all articulated cars behind the electronic-coupler;
wherein the same procedure is carried out in all electronic-couplers along the railway-vehicle;
whereas the holistic controller receives from the electronic-coupler sensor the information that the electronic-coupler is at the set-point, then
the holistic controller returns to the first phase of braking by:
maintaining the same angular-rotation of all-wheels along the railway-vehicle;
in the third phase of braking, when the electronic-coupler approach the “run-out” scenario, the holistic controller is:
configured to reduce in a fraction all articulated cars speed in front of the electronic-coupler, and simultaneously:
reduce in a fraction the brake-caliper's pressure in all articulated cars behind the electronic coupler;
whereas the same procedure is carried out in all electronic-couplers along the railway-vehicle;
when the holistic controller receives from the electronic-coupler sensor the information that the electronic-coupler is at the set-point, then
the holistic controller returns to the first phase of braking by:
maintaining the same angular-rotation of all-wheels along the railway-vehicle.

28. An electronic coupler for articulated cars in railway-vehicles, comprising:
a plurality of electronic-couplers is;
connected between articulated cars in railway-vehicles and in semi-trailers;
an electronic-coupler is:
configured with polymer or steel spring wedge system;
configured with multipart shaft;
configured with an IC hall-effect sensor;
configured with a readable plate having small metal projections, fixed to the shaft of the electronic coupler inside the draft gear unit that serve the IC hall-effect sensor to read the instant changing position of the electronic-coupler shaft;
an IC hall-effect sensor is:
configured to monitor the changing position of projections fixed to the plate fixed to the electronic-coupler shaft;
configured to monitor the instant changing status of the ‘free slack;’
configured to instantly transfer the monitored information to the holistic controller;
the holistic controller is:
configured to utilize multi-objective optimization design (MOOD) procedures;
configured to compute from the information received from the IC hall-effect sensor, the instant distance change between each end-to-end articulated cars along the railway-vehicle, and
activate the electric traction-motor and the brake-calipers in specific sequence to keep the best possible ‘free-slack’ between articulated cars, and to prevent a “run-in” or a “run-out” scenarios.

29. An integration of traction and all-wheel steering systems of claims 1 and 16, comprising:
a single yaw-sensor monitors and transmits by electronic means to the holistic controller the instant position of all-wheels in 1, 2 or 3 axle bogie configurations:
a holistic controller is:
configured with multi-objective optimization design (MOOD) procedures to:
evaluate the yaw-sensor information and compute the angle of each wheel;
compute the different distances all left and all right wheels along the railway-vehicle have to travel when they reach the curve;
actuates the left and the right electric traction-motor with a different torque and different speed when applicable, and
activate each steering-motor to bring each wheel along the railway-vehicle to the computed angle;
wherein the integration of electric traction-motor in the steering process assists the steering-motors while realizing a function of EPS [electric power-steering],
whereas contributing to virtually 100% dynamic efficiency.

30. An electric scalable tractive-system for a railway-vehicle according to claim 1, comprising:
an all-wheel electric traction-system in a locomotive and in selected wheels in articulated cars;
an all-wheel steering system in a locomotive and in all wheels in articulated cars;
a holistic controller is:
configured to control electric traction-motor torque and speed, and electric steering motors;
whereas a holistic controller cannot prevent a locomotive engineer from choosing any desired speed;
the holistic controller is:
configured with electronic torque and speed control over all electric traction-motors; and over all electric steering-motors operation, entered into the holistic controller date-base;
the holistic controller is:
further configured to utilize multi-objective optimization design (MOOD) program, including the locomotive and all articulated cars center of gravity information;
generate an algorithm that delivers a procedure to maintain in any combination of wheels angle and railway-vehicle speed, a safe forward motion, below a computed threshold-point that may overturn or endanger any part of the railway-vehicle stability:
whereas any attempt of the locomotive engineer to apply higher-speed that may endanger the stability of any part of the railway-vehicle or may trigger a derailment along the railway-vehicle, is automatically blocked by the holistic controller to prevent an accident.

31. An electric scalable tractive-system for railway-vehicle according to claim 16, comprising:
an all-wheel electric traction-system in a locomotive and in selected wheels in articulated cars;
an all-wheel steering system in a locomotive and in all wheels in articulated cars;
a holistic controller is:
configured to control electric traction-motor torque and speed, and electric steering motors;
whereas a holistic controller cannot prevent a locomotive engineer from choosing any desired speed;
the holistic controller is:
configured with electronic torque and speed control over all electric traction-motors; and over all electric steering-motors operation, entered into the holistic controller date-base;
the holistic controller is:
further configured to utilize multi-objective optimization design (MOOD) program, including the locomotive and all articulated cars center of gravity information;
generate an algorithm that delivers a procedure to maintain in any combination of wheels angle and railway-vehicle speed, a safe forward motion, below a computed threshold-point that may overturn or endanger any part of the railway-vehicle stability:
whereas any attempt of the locomotive engineer to apply higher-speed that may endanger the stability of any part of the railway-vehicle or may trigger a derailment along the railway-vehicle, is automatically blocked by the holistic controller to prevent an accident.
